(19) United States
(12) Patent Application Publication
(10) Pub. No.: US 2026/0149488 A1
(43) Pub. Date: May 28, 2026

(54) METHODS, PROCEDURES, AND DEVICES TO IMPROVE BEAM RESILIENCE IN MULTI-ANTENNA SYSTEMS WITH HYBRID BEAMFORMING

(71) Applicant: INTERDIGITAL PATENT HOLDINGS, INC., Wilmington, DE (US)

(72) Inventors: Javier LORCA HERNANDO, Madrid (ES); Patrick SVEDMAN, Stockholm (SE); Arman SHOJAEIFARD, London (GB); Kyle Jung-Lin PAN, Saint James, NY (US); Allan Yingming TSAI, Boonton, NJ (US)

(73) Assignee: INTERDIGITAL PATENT HOLDINGS, INC., Wilmington, DE (US)

(21) Appl. No.: 19/119,012

(22) PCT Filed: Oct. 6, 2023
(86) PCT No.: PCT/US2023/076193

§ 371 Date: Apr. 7, 2025

Related U.S. Application Data
(60) Provisional application No. 63/414,229, filed on Oct. 7, 2022.
(60) Provisional application No. 63/531,176, filed on Aug. 7, 2023.

(51) Int. Cl. H04B 7/0408

(52) U.S. Cl. CPC H04B 7/0408

(57) ABSTRACT

In an embodiment, a WTRU is configured to apply, to data symbols, a transform-spreading function that spreads the data symbols in a frequency domain, to form a first beam, and to transmit the transform-spread data symbols in the first beam. For example, an embodiment for improving reliability of signal detection over an impaired link includes implementing a Generalized Space-Frequency Block Coding (GSFBC) procedure. The impairment can be caused, e.g., by aging of the channel-state information, imperfections in the channel-state acquisition or reporting procedures, and/or beam-squint effects in multi-antenna systems. And an embodiment can include using hybrid beamforming and a GSFBC procedure to improve reliability of detection of the signal in the presence of beam squint and/or beam misalignments.

### CROSS-REFERENCE TO RELATED APPLICATIONS

This application claims the benefit of U.S. Provisional Application No. 63/414,229, filed Oct. 7, 2022, and U.S. Provisional Application No. 63/531,176, filed Aug. 7, 2023 the contents of which are incorporated herein by reference.

### SUMMARY

Embodiments of methods, procedures, and devices to improve link stability upon impairments caused by channel aging, imperfections in the channel-state acquisition or reporting procedures, and/or beam squint effects in multi-antenna systems, e.g., using hybrid beamforming or holographic beamforming, include a Generalized Space-Frequency Block Coding (GSFBC) procedure that is aimed to improve reliability of the detection in the presence of beam squint and/or beam misalignments.

Example methods and procedures for transmission of beams with improved link stability in multi-antenna systems can include one or more of the following operations:
Obtaining configuration information on the codebook of Transform Spreading functions and the thresholds T1 and T2;
Obtaining capabilities information containing, e.g., the subset of Transform Spreading functions supported by the receiver or any constraints related to the support of Generalized Space-Frequency Block Coding (GSFBC) procedure;
Obtaining measurements or reports of the link's performance degradation, e.g., the Signal-to-Noise Ratio (SNR) degradation caused by beam squint, S1, and/or the SNR degradation caused by beam misalignments, S2;
Obtaining beam-related scheduling information, e.g., about the beams serving other users or the available transmit power;
Selecting a function from the codebook of available Transform Spreading functions based on S1 above Threshold 1 (T1);
Selecting the Horizontal/Vertical (H/V) beam width and the orientation of a diversity beam based on S2 above T2 and a permission from the scheduler to use the diversity beam; and
Generating GSFBC-encoded symbols over the configured beams and sending GSFBC-related control signaling information.

Example methods and procedures for reception of beams with improved link stability in multi-antenna systems can include one or more of the following operations:
Obtaining configuration information on the codebook of Transform Spreading functions and the thresholds T3, T4, T5;
Sending capabilities information containing, e.g., the subset of supported Transform Spreading functions or any constraints related to the support of a Generalized Space-Frequency Block Coding (GSFBC) procedure;
Performing measurements of the link's performance degradation, e.g., the SNR degradation caused by beam squint, S3, and/or the SNR degradation caused by beam misalignments, S4;
Triggering a request to activate GSFBC encoding based on the user's velocity above T5;
Reporting a link's performance degradation caused by beam squint based on S3 above T3;
Reporting a link's performance degradation caused by beam misalignments based on S4 above T4;
Obtaining GSFBC-related control signaling information; and
Performing detection of GSFBC-encoded beams by performing Transform de-Spreading and Alamouti-based combining of the symbols in the main and/or diversity beams.

In another example, a WTRU is configured to apply, to data symbols, a transform-spreading function that spreads the data symbols in a frequency domain, to form a first beam, and to transmit the transform-spread data symbols in the first beam. For example, an embodiment for improving reliability of signal detection over an impaired link includes implementing a Generalized Space-Frequency Block Coding (GSFBC) procedure. The impairment can be caused, e.g., by aging of the channel-state information, imperfections in the channel-state acquisition or reporting procedures, and/or beam-squint effects in multi-antenna systems. And an embodiment can include using hybrid beamforming and a GSFBC procedure to improve reliability of detection of the signal in the presence of beam squint and/or beam misalignments.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of a hybrid beamforming architecture according to an embodiment.

FIG. 3 is a diagram of beam splitting to pre-compensate beam squint separately with two beams each carrying half of the subcarriers according to an embodiment.

FIG. 4 is a diagram of a base station and a device connected by, at least, a pair of beams according to an embodiment.

FIG. 5 is a diagram of transmit processing steps for GSFBC encoding including Transform Spreading and generation of a main beam and a diversity beam according to an embodiment.

FIG. 6 is a diagram of transmit processing steps for GSFBC encoding including Transform Spreading and single-beam transmission according to an embodiment.

FIG. 7 is a diagram of transmit processing steps for GSFBC encoding including Transform Spreading and transmission over two beams pointing at different directions and each containing a respective half of the subcarriers according to an embodiment.

FIG. 8 is a diagram of transmit processing steps for GSFBC encoding including generating of a main beam and a diversity beam according to an embodiment.

FIG. 9 is a diagram illustrating possibilities for a diversity beam (in blue/lighter shade) showing examples of widened beams in the same or an adjacent direction with respect to a main beam (in green/darker shade), and a beam in a different direction, in a single-TRP scenario, according to an embodiment.

FIG. 10 is a diagram illustrating a control signaling mechanism involved in the activation of GSFBC by the transmitter upon a request from the receiver according to an embodiment.

FIG. 11 is a flow diagram of signaling flow for a transmitting gNB triggering the activation/deactivation of GSFBC without a request from the receiving WTRU according to an embodiment.

FIG. 12 is a diagram of a geometrical arrangement of an array of antennas used for simulations with a UPA in the X-Z plane according to an embodiment.

FIG. 13 is a plot of results of simulations using the geometrical arrangement of antennas of FIG. 12 with beam squint and no beam misalignment according to an embodiment.

FIG. 14 is a plot of results of simulations using the geometrical arrangement of antennas of FIG. 12 with beam squint and random beam misalignments up to ±5% of the ideal direction according to an embodiment.

FIG. 15 is a plot of results of simulations using the geometrical arrangement of antennas of FIG. 12 with beam squint and random beam misalignments of up to ±10% of the ideal direction according to an embodiment.

FIG. 16 is a flow diagram for transmission signals of GSFBC-encoded signals according to an embodiment.

FIG. 17 is a flow diagram of a method related to the reception of GSFBC-encoded signals, according to an embodiment.

FIG. 18 is a block diagram of a receiver for GSFBC decoding according to an embodiment.

FIG. 19 is a flow diagram of a method for transmitting transform-spread data symbols in a beam according to an embodiment.

FIG. 20 is a flow diagram of a method for receiving data symbols in multiple beams according to an embodiment.

### DETAILED DESCRIPTION

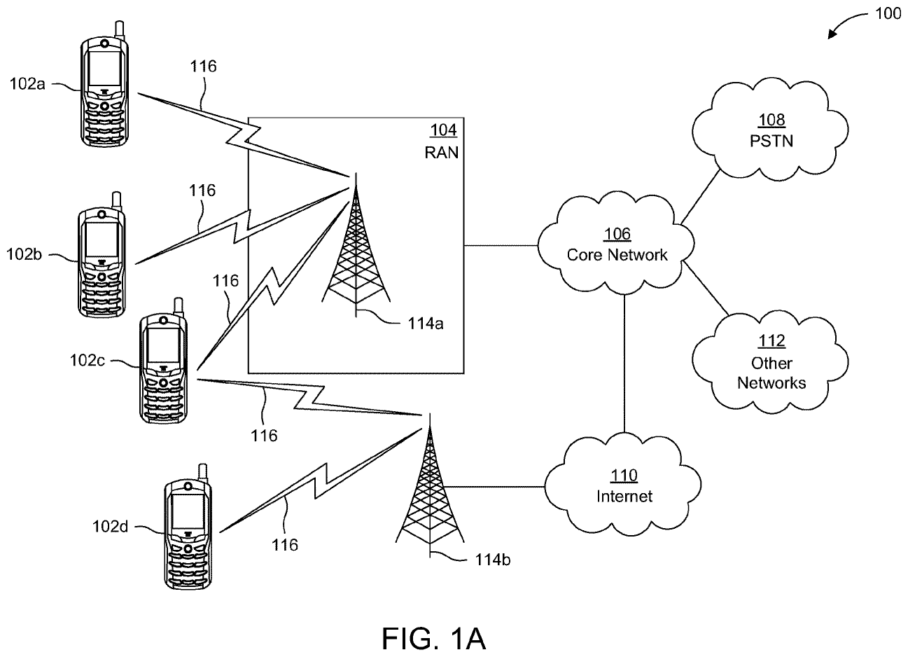

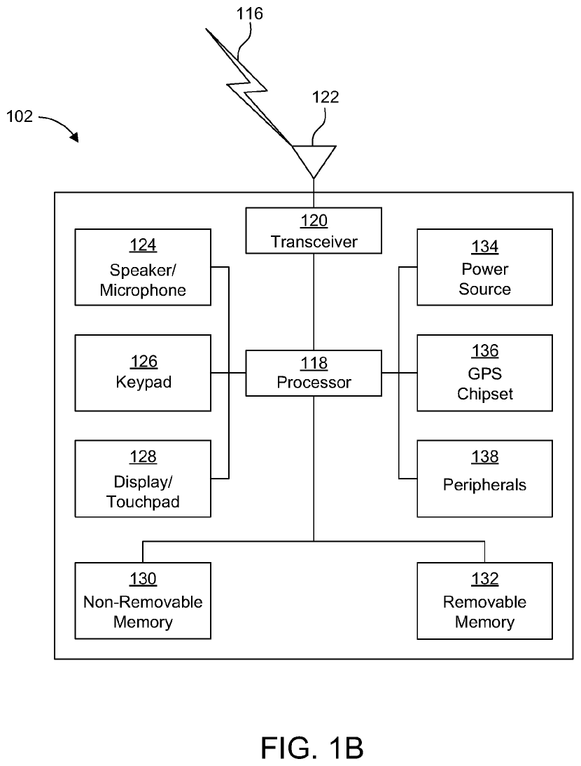

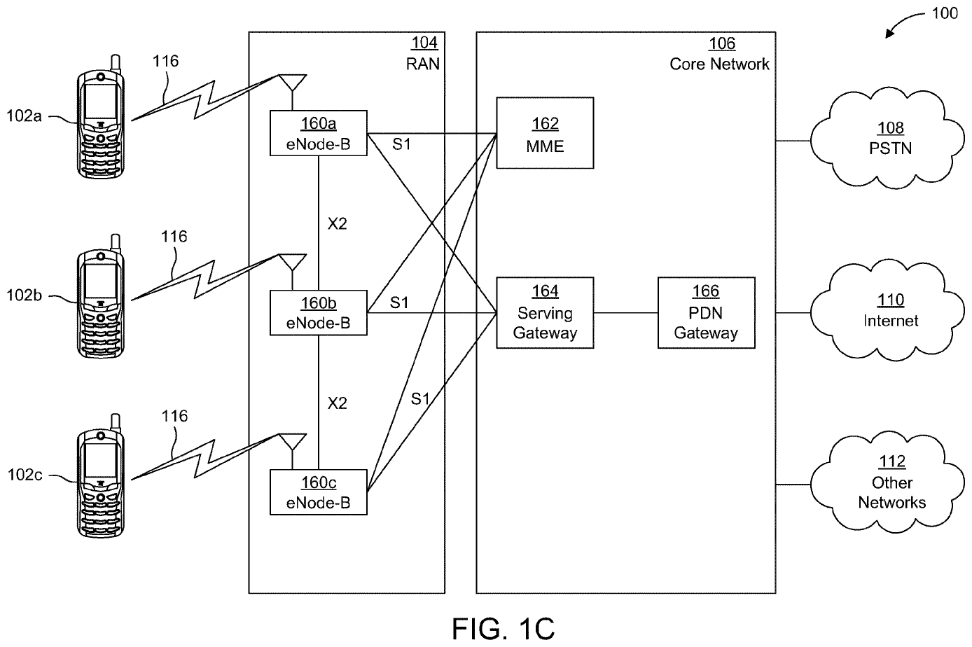

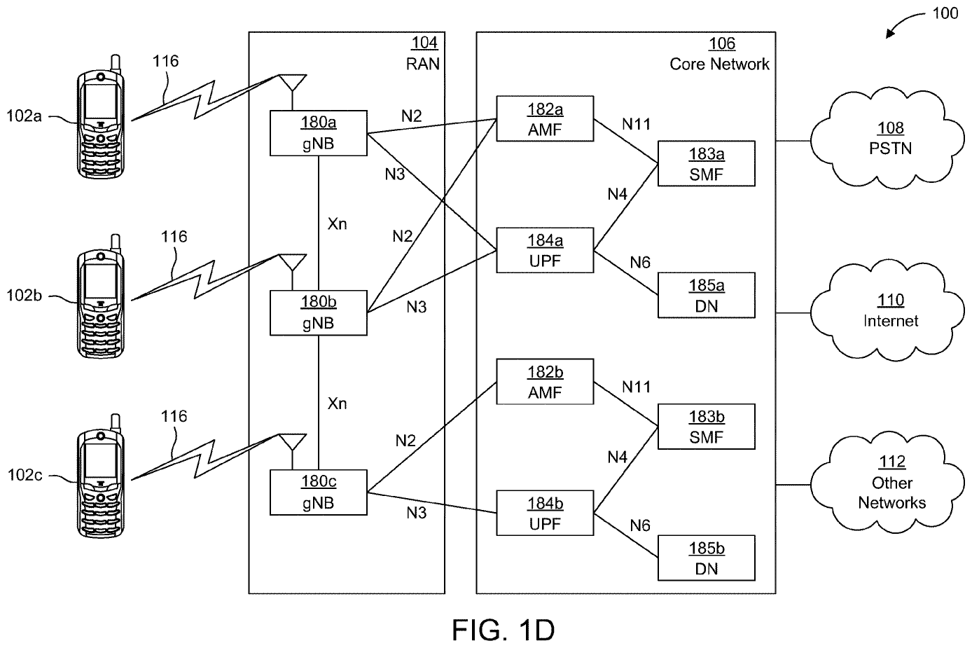

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special-purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or to receive RF signals. In an embodiment, the transmit/receive element 122 may be an emitter/detector configured to transmit and/or to receive IR, UV, or visible light signals, for example. In yet another embodiment, the transmit/receive element 122 may be configured to transmit and/or receive both RF and light signals. It will be appreciated that the transmit/receive element 122 may be configured to transmit and/or to receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel-metal-hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands-free headset, a Bluetooth® module, a frequency-modulated (FM) radio unit, a digital music player, a media player, a video-game player module, an Internet browser, a Virtual Reality and/or Augmented Reality (VR/AR) device, an activity tracker, and/or the like. The peripherals 138 may include one or more sensors. The sensors may be one or more of a gyroscope, an accelerometer, a hall-effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor, and/or the like.

The WTRU 102 may include a full-duplex radio for which transmission and reception of some or all of the signals (e.g., associated with particular subframes for both the UL (e.g., for transmission) and DL (e.g., for reception) may be concurrent and/or simultaneous. The full-duplex radio may include an interference-management unit to reduce and/or substantially to eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource-management decisions, handover decisions, scheduling of users in the UL and/or DL, and the like. As shown in FIG. 1C, the eNode-Bs 160a, 160b, and/or 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, and/or 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, and/or 102c with access to packet-switched networks, such as the Internet 110, to facilitate communications between the WTRUs 102a, 102b, and/or 102c and IP-enabled devices.

The CN 106 may facilitate communications with other networks. For example, the CN 106 may provide the WTRUs 102a, 102b, and/or 102c with access to circuit-switched networks, such as the PSTN 108, to facilitate communications between the WTRUs 102a, 102b, and/or 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, and/or 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be, and/or may be referred to as, peer-to-peer traffic. The peer-to-peer traffic may be sent directly or indirectly between the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest-bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, and/or 102c over the air interface 116. The RAN 104 may also be in communication with the CN 106.

The RAN 104 may include gNBs 180a, 180b, and/or 180c, though it will be appreciated that the RAN 104 may include any number of gNBs while remaining consistent with an embodiment. The gNBs 180a, 180b, and/or 180c may each include one or more transceivers for communicating with the WTRUs 102a, 102b, and/or 102c over the air interface 116. In one embodiment, the gNBs 180a, 180b, and/or 180c may implement MIMO technology. For example, gNBs 180a, 108b may utilize beamforming to transmit signals to and/or to receive signals from the gNBs 180a, 180b, and/or 180c. Thus, the gNB 180a, for example, may use multiple antennas to transmit wireless signals to, and/or to receive wireless signals from, the WTRU 102a. In an embodiment, the gNBs 180a, 180b, and/or 180c may implement carrier-aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, and/or 180c may implement Coordinated Multi-Point (CoMP) technology. For example, WTRU 102a may receive coordinated transmissions from gNB 180a and gNB 180b (and/or gNB 180c).

The WTRUs 102a, 102b, and/or 102c may communicate with gNBs 180a, 180b, and/or 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, and/or 102c may communicate with gNBs 180a, 180b, and/or 180c using subframe or transmission time intervals (TTIs) of various or scalable lengths (e.g., containing a varying number of OFDM symbols and/or lasting varying lengths of absolute time).

The gNBs 180a, 180b, and/or 180c may be configured to communicate with the WTRUs 102a, 102b, and/or 102c in a standalone configuration and/or a non-standalone configuration. In the standalone configuration, WTRUs 102a, 102b, and/or 102c may communicate with gNBs 180a, 180b, and/or 180c without also accessing other RANs (e.g., such as eNode-Bs 160a, 160b, and/or 160c). In the standalone configuration, WTRUs 102a, 102b, and/or 102c may utilize one or more of gNBs 180a, 180b, and/or 180c as a mobility anchor point. In the standalone configuration, WTRUs 102a, 102b, and/or 102c may communicate with gNBs 180a, 180b, and/or 180c using signals in an unlicensed band. In a non-standalone configuration, WTRUs 102a, 102b, and/or 102c may communicate with/connect to gNBs 180a, 180b, and/or 180c while also communicating with/connecting to another RAN such as eNode-Bs 160a, 160b, and/or 160c. For example, WTRUs 102a, 102b, and/or 102c may implement DC principles to communicate with one or more gNBs 180a, 180b, and/or 180c and one or more eNode-Bs 160a, 160b, and/or 160c substantially simultaneously. In the non-standalone configuration, eNode-Bs 160a, 160b, and/or 160c may serve as a mobility anchor for WTRUs 102a, 102b, and/or 102c and gNBs 180a, 180b, and/or 180c may provide additional coverage and/or throughput for servicing WTRUs 102a, 102b, and/or 102c.

Each of the gNBs 180a, 180b, and/or 180c may be associated with a particular cell (not shown) and may be configured to handle radio-resource management decisions, handover decisions, scheduling of users in the UL and/or DL, support of network slicing, DC, interworking between NR and E-UTRA, routing of user plane data towards User Plane Function (UPF) 184a, and/or 184b, routing of control-plane information towards Access and Mobility Management Function (AMF) 182a, and/or 182b and the like. As shown in FIG. 1D, the gNBs 180a, 180b, and/or 180c may communicate with one another over an Xn interface.

The CN 106 shown in FIG. 1D may include at least one AMF 182a, and/or 182b, at least one UPF 184a, and/or 184b, at least one Session Management Function (SMF) 183a, and/or 183b, and possibly a Data Network (DN) 185a, and/or 185b. While the foregoing elements are depicted as part of the CN 106, it will be appreciated that any of these elements may be owned and/or operated by an entity other than the CN operator.

The AMF 182a, and/or 182b may be connected to one or more of the gNBs 180a, 180b, and/or 180c in the RAN 104 via an N2 interface and may serve as a control node. For example, the AMF 182a, and/or 182b may be responsible for authenticating users of the WTRUs 102a, 102b, and/or 102c, support for network slicing (e.g., handling of different protocol-data-unit (PDU) sessions with different requirements), selecting a particular SMF 183a, and/or 183b, management of the registration area, termination of non-access stratum (NAS) signaling, mobility management, and the like. Network slicing may be used by the AMF 182a, and/or 182b in order to customize CN support for WTRUs 102a, 102b, and/or 102c based on the types of services being utilized WTRUs 102a, 102b, and/or 102c. For example, different network slices may be established for different use cases such as services relying on ultra-reliable low-latency (URLLC) access, services relying on enhanced-massive-mobile-broadband (eMBB) access, services for MTC access, and the like. The AMF 182a, and/or 182b may provide a control-plane function for switching between the RAN 104 and other RANs (not shown in FIGS. 1A-1D) that employ other radio technologies, such as LTE, LTE-A, LTE-A Pro, and/or non-3GPP access technologies such as WiFi.

The SMF 183a, and/or 183b may be connected to an AMF 182a, and/or 182b in the CN 106 via an N11 interface. The SMF 183a, and/or 183b may also be connected to a UPF 184a, and/or 184b in the CN 106 via an N4 interface. The SMF 183a, and/or 183b may select and control the UPF 184a, and/or 184b and configure the routing of traffic through the UPF 184a, and/or 184b. The SMF 183a, and/or 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, and/or 184b may be connected to one or more of the gNBs 180a, 180b, and/or 180c in the RAN 104 via an N3 interface, which may provide the WTRUs 102a, 102b, and/or 102c with access to packet-switched networks, such as the Internet 110, to facilitate communications between the WTRUs 102a, 102b, and/or 102c and IP-enabled devices. The UPF 184, and/or 184b may perform other functions, such as routing and forwarding packets, enforcing user-plane policies, supporting multi-homed PDU sessions, handling user-plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, and/or 102c with access to the other networks 112, which may include other wired and/or wireless networks that are owned and/or operated by other service providers. In one embodiment, the WTRUs 102a, 102b, and/or 102c may be connected to a local DN 185a, and/or 185b through the UPF 184a, and/or 184b via the N3 interface to the UPF 184a, and/or 184b and an N6 interface between the UPF 184a, and/or 184b and the DN 185a, and/or 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### ABBREVIATIONS AND ACRONYMS

3GPP Third Generation Partnership Project
4G 4^{th} Generation
5G 5^{th} Generation
AWGN Additive White Gaussian Noise
BER Bit Error Rate
BLER Block Error Rate
CA Carrier Aggregation
CBM Common Beam Management
CC Component Carrier
CP-OFDM Cyclic Prefix-Orthogonal Frequency Division Multiplexing
CSI Channel State Information
CSI-RS Channel State Information-Reference Signal
DC Direct Current
DCI Downlink Control Information
DCT Discrete Cosine Transform
DFE Decision-Feedback Equalizer
DFT Discrete Fourier Transform
DFT-s-OFDM Discrete Fourier Transform-spread Orthogonal Frequency Division Multiplexing
DL Downlink
DLCT Discrete Linear Chirp Transform
DM-RS Demodulation Reference Signal
DST Discrete Sine Transform
DWHT Discrete Walsh-Hadamard Transform
DWT Discrete Wavelet Transform
EIRP Effective Isotropic Radiated Power
EIS Effective Isotropic Sensitivity
FR1 Frequency Range 1
FR2-1 Frequency Range 2-1
GSFBC Generalized Space-Frequency Block Coding
IBM Independent Beam Management
ICI Inter-Carrier Interference
LMMSE Linear Minimum Mean Squared Error
LTE Long-Term Evolution
MAC CE Medium Access Control-Control Element
MIMO Multiple Input Multiple Output
MU-MIMO Multi-User Multiple Input Multiple Output
NR New Radio
OFDM Orthogonal Frequency Division Multiplexing
PA Power Amplifier
PDCCH Physical Downlink Control Channel
PDSCH Physical Downlink Shared Channel
PSS Primary Synchronization Signal
PT-RS Phase Tracking-Reference Signal
PUSCH Physical Uplink Shared Channel
QCL Quasi-Co-Located
RB Resource Block
RF Radio Frequency
RRC Radio Resource Control
SFBC Space-Frequency Block Coding
SNR Signal to Noise Ratio
SSS Secondary Synchronization Signal
SU-MIMO Single User-Multiple Input Multiple Output
TRP Transmit-Receive Point
TRX Transmit-Receive
TTI Transmission Time Interval
TX Transmitter
UE User Equipment
UPA Uniform Planar Array
UMTS Universal Mobile Telecommunication System
WTRU Wireless Transmit/Receive Unit

One or more embodiments are related to the field of wireless communications, and more precisely to methods and procedures to improve link robustness in high-frequency systems where the communication is achieved by means of transmit and receive beams generated through beamforming.

Related to hybrid beamforming, 5^{th} Generation (5G) NR Standards already support so-called millimeter-wave (mmWave) radio frequencies, i.e., frequencies above 6 GHz characterized by large chunks of spectrum potentially available for wireless communications. So-called Frequency Range 2-1 (FR2-1) comprises the mmWave radio spectrum between 24.25 GHz and 52.6 GHz in existing specifications. In addition, Frequency Range 2-2 (FR2-2) comprises the mmWave radio spectrum between 52.6 GHz and 71 GHz. In these frequencies, radio propagation can be more stringent than in lower frequencies because of the higher propagation losses caused by a lower effective antenna aperture in single-antenna systems. To compensate for this higher-propagation loss, beamforming is often implemented using multi-antenna structures at both the transmitter and receiver sides to increase the signal gain.

At very high frequencies, the wavelength can be so small (on the order of millimeters) that the number of antennas needed to overcome the stringent link budget is very large, e.g., usually 512, 1024 or even more, thus making it challenging to implement as many TRX chains as would be required in fully digital-beamforming architectures. That is the reason why hybrid beamforming is extensively employed in FR2-1, with a fewer number of TRX chains (e.g., 2 or 4) that excite a much larger number of antenna elements (e.g., on the order of 1024 or more) using, e.g., phase shifters or on/off switching of antennas in RF lenses. Hybrid beamforming is convenient to reduce the complexity of the transceiver design but may come at the cost of a reduced flexibility for spatial multiplexing. Each of the TRX chains can generate a single beam towards a spatial direction as determined by the phase shifters. Digital precoding of the beams is further performed to spatially multiplex the beams towards different users. However, it may not be possible to digitally precode the signals of the individual antenna elements as in digital-beamforming architectures.

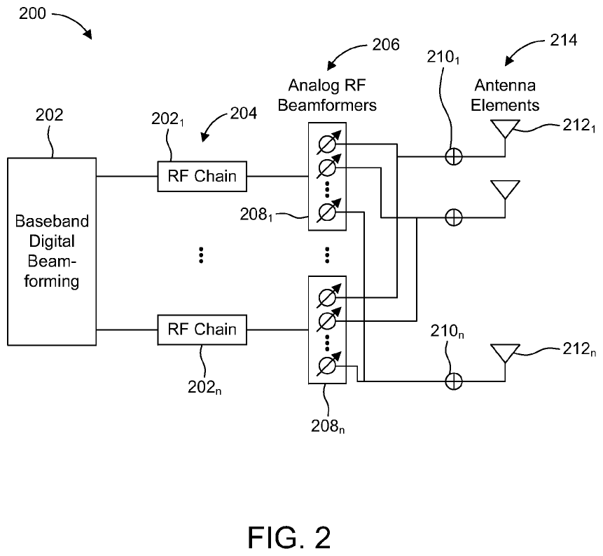

FIG. 2 is a diagram of a hybrid-beamforming circuit 200 having a hybrid-beamforming architecture according to an embodiment.

Referring to FIG. 2, a baseband digital-beamforming stage 202 provides respective data streams to corresponding RF chains 202₁-202₀, of an RF-chain stage 204, the RF chains driving drive an analog-beamforming stage 206, which includes analog RF beamformers 208₁-208ₙ. The analog-beamforming stage 206 steers the beams (not shown in FIG. 2) towards the desired direction in space by means of, e.g., as many phase shifters and/or on/off switches 210 (210₁-210ₙ shown in FIG. 2) as the number of antenna elements 212₁-212ₙ of an antenna 214 multiplied by the number of TRX chains. It may not be possible to individually control the amplitude and phases of the signals at the antenna elements but only the relative phases introduced by the phase shifters to steer the beams, usually under the restriction of having a discrete grid of beams with pre-defined sets of phase shifts per each beam. Moreover, traditional phase shifters have a narrowband response and can apply only a constant phase shift across frequency. Other architectures employ RF lenses (not shown in FIG. 2) for the analog-beamforming stage 206, where the lenses exhibit some frequency dependence on the dielectric permittivity of the material(s) from which the lenses are made.

One of the potential shortcomings of hybrid beamforming is that a beam cannot be split in the frequency domain to simultaneously point towards different directions in space (e.g., to address different users or spatially multiplex different layers to a given user), because phase shifters (or switches in RF lenses) impose the beam direction on the whole carrier, e.g., on all subcarriers of an OFDM symbol or of a DFT-s-OFDM symbol. Hereinafter, for purposes of explanation, we mainly consider beams with a single main lobe in a certain direction (ideally accomplished in absence of impairments with one set of phase shifts) to attain the highest beamforming gain. Hence, beamformed transmission may be accomplished using one set of phase shifts at a time, and transmissions to different devices located in different directions relative to the base station are, therefore, separated in the time or space domains, not in the frequency domain. Similarly, the beams at the receive side may be accomplished using one set of phase shifts at a time. But accomplishing the beamformed transmission and the beams at the receive side in this manner may limit the flexibility of the scheduler that partitions resources in the time, frequency, and space domains to multiplex the users.

Regarding beam management issues at very high frequencies, 5G NR Release 15 already standardized a comprehensive framework for beam management. Beam management is responsible for initially setting a pair of transmit-receive beams, refining them during the communication to improve signal quality, detecting beam failures, and successfully recovering from these failures. Broadly speaking, beam management is based on tracking and reporting of the quality of the beams as measured by the receiver side on sets of pre-defined resource elements, like the Channel State Information Reference Signal (CSI-RS) in 4G and 5G, so that the best beam pair is selected (e.g., always selected) throughout the communication. This beam-management procedure involves some control signalling, the overhead of which increases with the rate of changes of the selected beam pair.

There are multiple reasons for performing beam changes throughout the communication. One reason is mobility, i.e., the movement of a device (e.g., a WTRU) with respect to a line-of-sight direction towards the base station. Rotational mobility of the device also can lead to frequent beam changes even in absence of a net user movement, e.g., as caused by slight rotations of handheld devices, sensors, or other connected equipment in industrial-like environments. In these cases, frequent beam changes may be triggered by the beam management process as a result of continuously sensing the channel and reporting its quality. However, CSI measurements may be impaired by noise or other imperfections that can lead to errors in the beam-selection process, and may suffer from channel aging when the channel measured at the time when CSI was reported is different than the channel experienced at the moment of transmission. As a result, the selected beam pair may not be the optimal beam pair and subsequent channel measurements may trigger further beam reselections, with the corresponding extra signalling overhead. This issue is more pronounced at very high frequencies because of the narrower beams used to overcome the excess pathloss.

At very high frequencies, one of the most serious impairments when dealing with wide bandwidths is the so-called frequency-wideband effect, also known as beam squint, by which the beam's orientation deviates from its ideal value by an amount that increases with the distance of the beam frequency to the carrier frequency. Beam squint is caused by the narrowband characteristic of phase shifters, and/or the frequency-dependent dielectric permittivity of RF lenses, which can be responsible for steering the beams in hybrid beamforming architectures. This effect is more noticed when the fractional bandwidth of the signal (i.e., the bandwidth divided by the centre frequency) is large. Beam squint can cause up to 5-6 dB array gain loss when the fractional bandwidth is only 10%, a loss figure that can be easily surpassed at THz and sub-THz frequencies due to the potentially large available bandwidths in these bands.

The magnitude of the beam-squint effect depends on the frequency distance of a beam to the carrier frequency and on the number of transmit and/or receive antennas. As the number of antennas in a transmitting/receiving entity is typically an implementation feature not signalled to the other peer, it is sometimes not possible to predict the severity of beam squint until its impact is measured by the receiver side. Similarly, issues resulting from beam misalignments are ultimately determined by the number of antennas at both transmitting and receiving sides and typically cannot be predicted by the transmitter before the beam misalignment (or one or more parameters indicative of beam misalignment) are measured by the receiver.

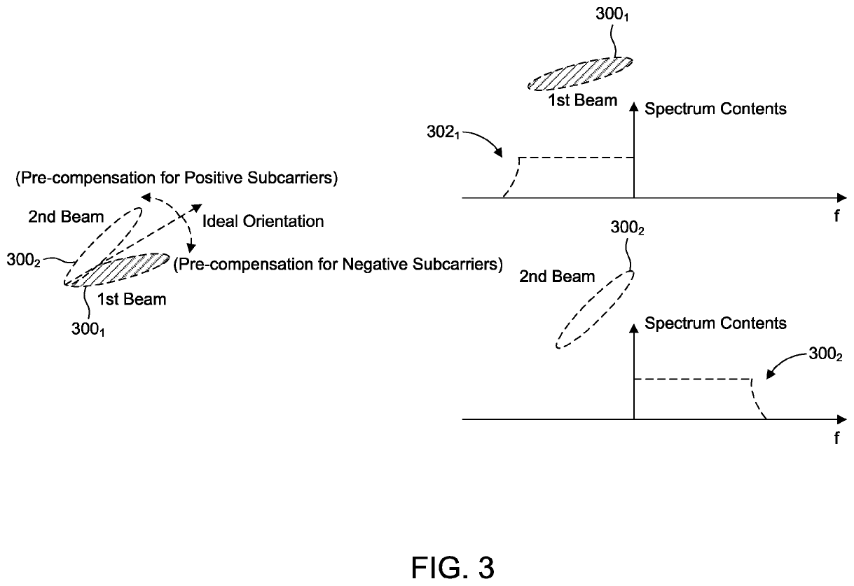

FIG. 3 is a diagram of beam splitting to pre-compensate beam squint separately with two beams each carrying half of the subcarriers according to an embodiment.

Referring to FIG. 3, an example for mitigating beam squint can involve splitting the transmit beam into two or more beams (e.g., two beams 300₁ and 300₂), each beam containing a subset (e.g., two subsets 302₁ and 302₂) of the allocated subcarriers and pointing at different directions to pre-compensate for the average deviation incurred in each frequency region. As an example, a user can be addressed by a pair of beams 300₁ and 300₂ each steered at slightly different pre-defined directions and each allocating half of the subcarriers for that user. More beams can be used depending on the maximum allowed magnitude of beam squint.

This technique, while effectively halving the maximum frequency distance (and, therefore, the maximum severity of beam squint) in each beam 300₁ and 300₂, may be unable to mitigate the losses caused by beam misalignments as such misalignments can affect equally all the beams regardless of their orientations.

Regarding Alamouti-based diversity, in conventional implementations and so-called Frequency Range 1 (FR1, below 7.125 GHz), transmit-diversity schemes based on Alamouti space-time coding have been extensively used to enhance the reliability of detection. A variation of the Alamouti scheme involving Space-Frequency Block Coding (SFBC) is used in 3GPP Long-Term Evolution (LTE) standards. This type of encoding yields a diversity order two (2) while keeping the same symbol rate of the communication, i.e., without increasing the bitrate. Alamouti space-time coding was also considered in Universal Mobile Telecommunication System (UMTS) and its evolutions. 5G NR standards do not explicitly consider transmit diversity, but any vendor-specific implementation scheme that is transparent to the device can be used to improve the detection reliability, like, e.g., cyclic-precoding or antenna-switching schemes.

Regarding common and independent beam management in 3GPP, 3GPP engineers and other developers studied the impact of beam-squint effects in FR2 scenarios. The radiative degradation caused by beam squint is more apparent in inter-band and intra-band Carrier Aggregation (CA) when a common beam management (CBM) scheme is adopted. In CBM, WTRUs select their DL receive beams for all the Component Carriers (CCs) in all configured bands based on DL measurements made in the only CC configured with the reference signal for beam management. As a result, there can be an impact on performance when beam squint appears because of having large frequency separation between the CCs, and NR allows relaxing Effective Isotropic Sensitivity (EIS) for some CCs. In contrast, a WTRU that supports inter-band CA with Independent Beam Management (IBM) selects its DL receive beam(s) for all CCs in each configured band based on DL reference signals measurements made in that band. Measurements in that band, therefore, can lead to reduced impact from beam squint as per the smaller frequency separation between the frequency edges compared to CBM.

3GPP engineers and other developers assessed beam-squint effects in FR2 inter-band DL CA scenarios further studying the impact on the EIS and the Effective Isotropic Radiated Power (EIRP) in compliance testing. However, operation at sub-THz and THz frequencies may be impaired even in absence of inter-band CA if the bandwidth allocation is large enough to introduce significant degradation. IBM may mitigate the issue in this case by performing independent beam management of two beams at possibly different directions, but such mitigation may not be efficient as it can significantly increase the associated control signalling from the additional receive beam set by the WTRU.

Conventional beam-management techniques based on tracking of a best-beam pair at the transmitter and receiver sides may incur extra beam reselections and signalling overhead when significant translational mobility, rotational mobility, or beam squint, are present. These issues are especially severe at very high frequencies because of at least the following reasons:
Channel aging caused by either mobility or imperfections from CSI measuring/reporting may be especially significant at very high frequencies, because of the narrowness of the beams and the higher impact from Doppler (which linearly increases with the carrier frequency).
WTRUs and other transmitters/receivers may be unable to digitally correct, at the antenna level, beam squint at very high frequencies to compensate for a beam's deviation in typical hybrid beamforming architectures employing narrowband phase shifters or RF lenses with frequency-dependent dielectric permittivity. Beam squint can lead to an SNR loss at the subcarriers located farthest from the carrier frequency, and this SNR loss can lead to a slanted frequency response even in perfectly flat channels. These impaired subcarriers degrade the overall link quality compared to the no-beam-squint case, sometimes regardless of the modulation and coding scheme used, because symbols do not “see” the same channel response anymore. As previously proven, performance can be improved if all symbols experience the same channel gain when CSI is known only at the receiver. Due to the uncertainty in the combined-beam-squint effect caused by the transmitter and receiver, and the unpredictability of any errors caused by channel aging, a transmitter may be unable to exploit the instantaneous CSI to improve detection. Under these conditions, it is known that performance is typically best when symbols experience the same channel gain over the time and frequency domains.
Splitting of the beams with a-priori pre-compensation of their spatial orientation to mitigate beam squint may be ineffective when random misalignments appear, e.g., from unpredictable rotations or imperfections in the beam-selection process. Robustness against beam misalignments can be especially important at very high frequencies where beams are so narrow that deviations of, e.g., even just a few degrees can significantly degrade the communication.
Alamouti-based diversity schemes, traditionally used to improve the detection statistics in poor link conditions or when there is significant channel aging, rely on the presence of uncorrelated transmit antennas with essentially independent channel responses. Traditional Alamouti schemes may need further work (e.g., modification) before being applicable to beamformed systems at high frequencies. On the one hand, a diversity beam identical to the main beam will bring no advantages as the channel responses of the beams will be similar, hence not rendering any statistical gain: for example, only 3 dB SNR gain at the expense of 3 dB more power, with zero net gain. On the other hand, a diversity beam pointing towards a different direction than the main beam (and whose channel response is uncorrelated with that of the main beam) may improve the statistics of the signal, but is feasible only if reflections (e.g., multipath) exist to help the diversity beam reach the receiver, i.e., if the direction of the diversity beam is also a strong eigen-vector of the system. This may be difficult in some line-of-sight scenarios where the receive spatial filtering may significantly block most of the multipath components outside the receiver's beam width. Moreover, both beams can be subject to similar (and unpredictable) degradations from beam misalignments, which can render the diversity beam largely ineffective in this case.
Alamouti diversity may not be useful to overcome beam squint because the SNR degradation at the farthest subcarriers are also present in the diversity beam, thus leading to a slanted frequency response. As is known, performance is improved, and is often best, when the data symbols experience the same channel gain in the time or frequency domains for a given overall SNR. This fact calls for a need to devise better mitigation methods to reduce the channel's frequency selectivity induced by beam squint.
The approach to consider independent beams in 3GPP to tackle beam squint mainly focuses on CA scenarios but may be less efficient in non-CA scenarios with a single component carrier because of the signaling increase required to keep track of the two beams.

Better schemes, therefore, may improve link stability in multi-antenna systems based on, e.g., hybrid beamforming or holographic beamforming, that are subject to impairments from mobility, CSI imperfections, lack of accuracy in CSI measurements, and/or beam squint.

Embodiments of methods and procedures disclosed herein improve link stability in the presence of channel aging, impairments related to channel-state acquisition or reporting, and/or beam-squint effects in multi-antenna systems, e.g., using hybrid beamforming or holographic beamforming, but possibly also other schemes like digital beamforming, holographic beamforming, and others capable of steering the beams at a desired direction in space.

The following techniques are described as part of one or more embodiments described further below.

Regarding generalized space-frequency block coding (GSFBC), according to one or more embodiments, described is a coding scheme (hereinafter denoted as GSFBC) that is suitable to cope with the above-described beam impairments.

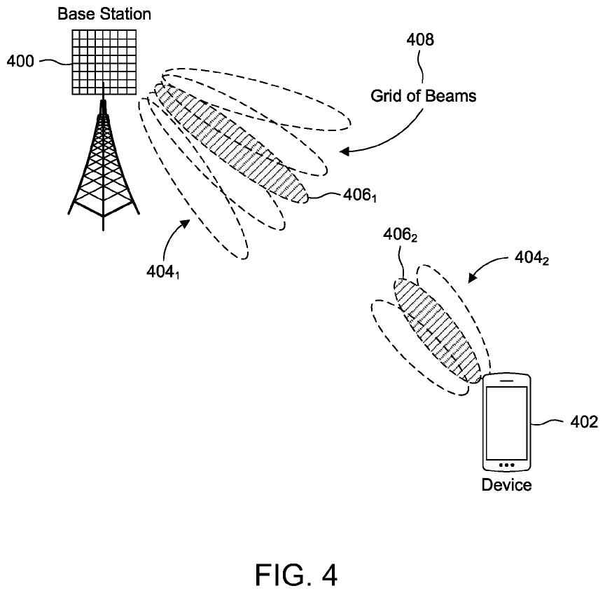

FIG. 4 is a diagram of a base station 400 and a device 402 connected by, at least, a pair of beams 404₁ and 404₂, according to an embodiment. The best beam pair 406ₐ and 406₁ is highlighted as part of the grid of beams 408.

For example purposes, there is a scenario for transmission and reception of wireless signals where both the transmitting and receiving entities 400 and 402 are capable of steering the beams towards different directions in space, as illustrated in FIG. 4. Beamforming is assumed to compensate for the excess losses incurred by the propagation channel at very high frequencies, especially at sub-THz and THz. To this end, a pair of transmit and receive beams is set up at initial access and further refined to regularly update the spatial orientation of each of the transmit and receive beams of the pair for best performance. However, channel aging caused by user movements and imperfections in CSI acquisition or reporting may degrade the SNR and ultimately trigger further beam reselections. Beam squint, if present, may pose further challenges as beam reselection alone may be unable to mitigate the impact of the frequency-dependent deviation of the beams with respect to their ideal orientations.

To cope with this scenario, a generalized space-frequency block coding (GSFBC) procedure is described that can include a diversity beam and a space-frequency coding procedure that can generate complex symbols s⁽¹⁾ and s⁽²⁾, which are to be transmitted simultaneously using two beams, with s⁽¹⁾ being carried by the main beam and s⁽²⁾ by the diversity beam. The diversity beam and the generalized space-frequency coding procedure are configured to mitigate the effects of beam misalignments (e.g., from channel aging or CSI imperfections), beam squint, and/or any other unpredictable beam impairments affecting performance. In a scenario with multiple Transmit-Receive Points (multi-TRP), the diversity beam may be transmitted by the same or a different TRP to reinforce diversity. In an embodiment, as will be explained, either the diversity beam or the space-frequency coding procedure may be avoided depending on the impairments addressed and the characteristics of the transceiver nodes.

The corresponding transmit and receive processing steps of GSFBC are described according to an embodiment.

Assume a block of M complex modulated data symbols (where M is even),

$${x}^{( 1 )} = \{ {x}_{1} , … , {x}_{M} \} \qquad Equation ( 1 )$$

Throughout the description of this example, it is assumed that the symbols are mapped to suitable frequency-domain subcarriers in a CP-OFDM symbol, but the methods herein may be equally applicable to other waveforms, modulation techniques, and other multicarrier/single-carrier waveforms.

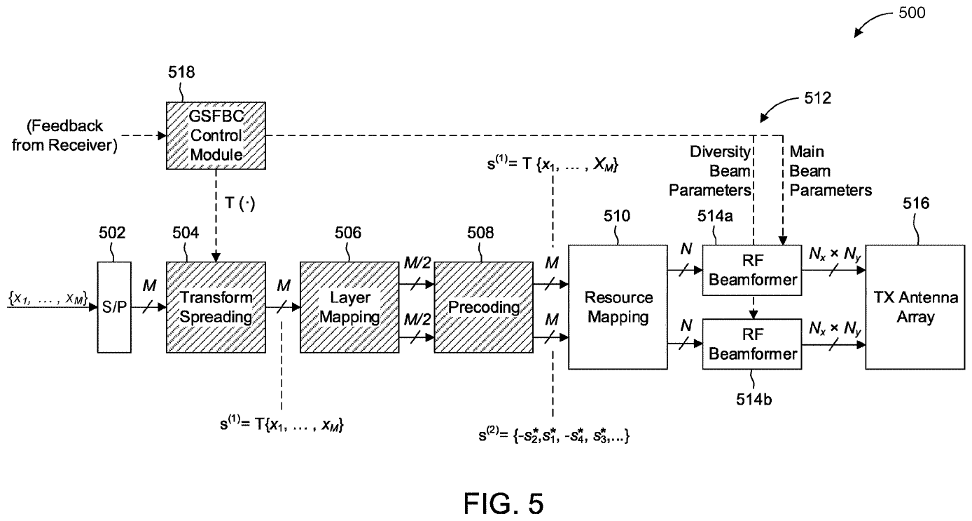

FIG. 5 is a schematic diagram of a transmit-processing circuit (e.g., a transmitting path or transmitting circuit) 500 configured to implement transmit-processing steps for GSFBC encoding including Transform Spreading and generation of a main beam and a diversity beam, according to an embodiment.

To increase beam resilience under potential impairments from mobility, beam-squint effects, and/or other reasons, an embodiment of a generalized space-frequency block coding procedure involves a Transform Spreading circuit/step and circuits/methods for generating a diversity beam to provide extra link resilience. Referring to FIG. 5, at least the transmit-processing circuit(s)/step(s) highlighted in the crosshatched blocks represent improvements over conventional procedures.

Still referring to FIG. 5, a series-to-parallel converter 502 is configured to convert the modulated data symbols x⁽¹⁾ of Equation (1) from a serial form to parallel form.

A transform-spreading circuit 504 is configured to apply a spreading transform (a transform function that spreads the modulated data symbols x⁽¹⁾ in frequency) to the parallel modulated data symbols x⁽¹⁾ from the serial-to-parallel converter 502 to generate spread modulated data symbols s) according to the following equation:

$${s}^{( 1 )} = 𝒯 \{ {x}_{1} , … , {x}_{M} \} = \{ {s}_{1} , … , {s}_{M} \} \qquad Equation ( 2 )$$

A layer-mapping circuit 506 is configured to map the spread modulated data symbols s⁽¹⁾ from the transform-spreading circuit 504 onto a first data stream for a first transmit beam and onto a second data stream for a second transmit beam (e.g., a diversity transmit beam, or “diversity beam”). For example, the layer-mapping circuit 506 can generate the first data stream equal to s⁽¹⁾ for modulating some or all (e.g., half) of the N available subcarriers in the first transmit beam, and can generate the second data stream equal to the complex conjugates (s⁽²⁾) of s⁽¹⁾ for modulating some or all (e.g., the other half) of the N available subcarriers in the second beam.

A precoding circuit 508 is configured to precode the first mapped data stream of the spread modulated data symbols s⁽¹⁾ (Equation (2)) and to precode the second mapped data stream of spread modulated conjugate data symbols s⁽²⁾ from the layer-mapping circuit 506 according to the following equation:

$${s}^{( 2 )} = \{ - {s}_{2}^{*} , {s}_{1}^{*} , - {s}_{4}^{*} , {s}_{3}^{*} , … \} \qquad Equation ( 3 )$$

A resource-mapping circuit 510 is configured to map resources to the first precoded data stream and to the second precoded data stream, e.g., by allocating a first set of subcarriers within the N available subcarriers to the precoded symbols of the first precoded data stream at a given frequency location, and a second set of subcarriers within the N available subcarriers to the precoded symbols of the second precoded data stream at a same or different frequency location, where M≤N.

An RF beamformer circuit 512 includes a first RF beamformer 514a and a second (e.g., diversity) RF beamformer 514b configured to form the first transmit beam from the first resource-mapped data stream generated by the resource-mapping circuit 510 and to form the second (e.g., diversity) beam from the second resource-mapped data stream generated by the resource-mapping circuit.

And a transmit antenna array 516 is configured to generate (in the transmission medium) and to transmit the first transmit beam and the second (e.g., diversity) beam) in response to the first and second formed beams from the RF beamformer 512.

Still referring to FIG. 5, a receiver of a device (e.g., a base station gNB or WTRU) that receives the first and second (e.g., diversity) beams from the antenna array 516 can provide feedback to a GSFBC control-module circuit 518 of the transmit circuit 500, which is typically located in another device (e.g., another WTRU or another gNB), where the feedback can include one or more signal-related parameters such as channel-state information, error rate, and/or SNR at the receiver. In response to the feedback, the control-module circuit 518 is configured to control the transform-spreading circuit 504 to adjust the spreading transform, and/or is configured to control the RF beamforming circuit 512 to adjust one or more parameters (e.g., beam half-power width, beam direction, and/or subcarriers on each beam) to improve the quality of the received (at the receiver) signal(s) carrying the data symbols.

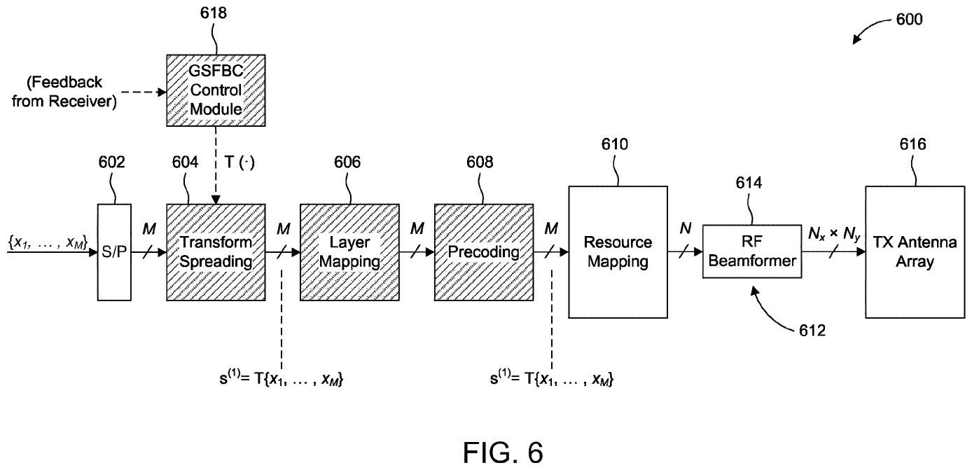

FIG. 6 is a diagram of transmit-processing circuit 600 configured to perform steps for GSFBC encoding including Transform Spreading and single-beam transmission, according to an embodiment.

Referring to FIG. 6, in an embodiment, a generalized space-frequency block coding procedure involves a Transform Spreading step to provide extra resilience to beam-squint effects in single-beam transmission with no additional diversity beam.

Still referring to FIG. 6, a series-to-parallel converter 602 is configured to convert the modulated data symbols x⁽¹⁾ of Equation (1) from a serial form to parallel form.

A transform-spreading circuit 604 is configured to apply a spreading transform to the parallel modulated data symbols x⁽¹⁾ from the serial-to-parallel converter 602 to generate spread modulated data symbols s⁽¹⁾ according to Equation (2).

A layer-mapping circuit 606 is configured to map the spread modulated data symbols s^{(l)} from the transform-spreading circuit 504 onto a single data stream for a single transmit beam.

A precoding circuit 608 is configured to precode the single mapped data stream of the spread modulated data symbols s⁽¹⁾ still according to Equation(2).

A resource-mapping circuit 610 is configured to map resources to the single precoded data stream, e.g., by allocating a set of subcarriers (for example, out of N available subcarriers) to the precoded symbols of the single precoded data stream at a given frequency location.

An RF beamformer circuit 612 includes ant RF beamformer 614 configured to form the singlet transmit beam from the single resource-mapped data stream generated by the resource-mapping circuit 610.

And a transmit antenna array 616 is configured to generate (in the transmission medium) and to transmit the single transmit beam in response to the single formed beam from the RF beamformer 612.

Still referring to FIG. 6, a receiver of a device (e.g., a base station gNB or WTRU) that receives the single beam from the antenna array 616 can provide feedback to a GSFBC control-module circuit 618 of the transmit circuit 600, which is typically located in another device (e.g., another WTRU or another gNB), where the feedback can include one or more signal-related parameters such as channel-state information, error rate, and/or SNR at the receiver. In response to the feedback, the control-module circuit 618 is configured to control the transform-spreading circuit 604 to adjust the spreading transform to improve the quality of the received (at the receiver) signal(s) carrying the data symbols.

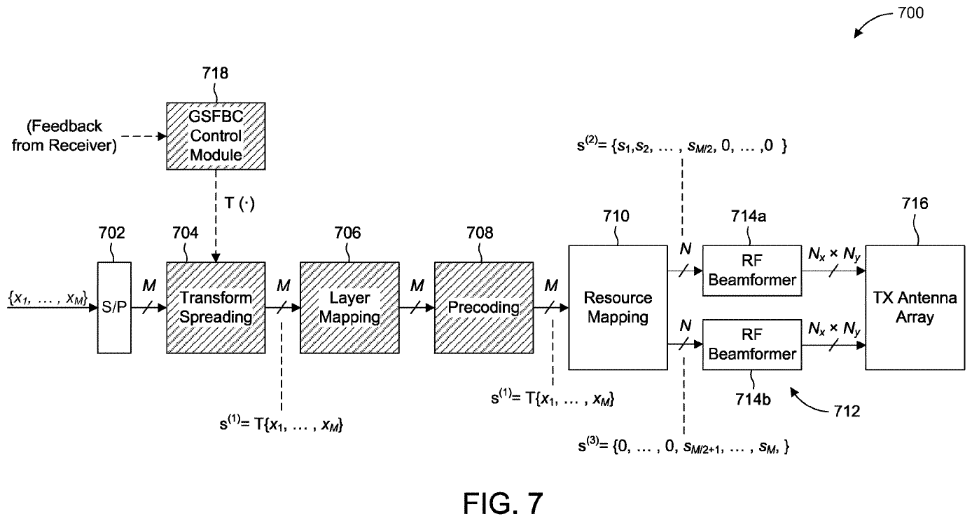

FIG. 7 is a diagram of transmit-processing circuit 700 configured to perform steps for GSFBC encoding including Transform Spreading and transmission over two beams (e.g., a first, main, beam and a second, diversity, beam) pointing at different directions and each containing a respective half of the subcarriers, according to an embodiment.

Referring to FIG. 7, in yet another embodiment, a circuit and a method performed by the circuit involves splitting of the main beam into two beams pointing at different directions in space and each containing a respective half of the subcarriers allocated for transmission, and a Transform Spreading step to provide extra resilience against beam squint for both beams.

Still referring to FIG. 7, a series-to-parallel converter 702 is configured to convert the modulated data symbols x⁽¹⁾ of Equation (1) from a serial form to parallel form.

A transform-spreading circuit 704 is configured to apply a spreading transform to the parallel modulated data symbols x⁽¹⁾ from the serial-to-parallel converter 702 to generate spread modulated data symbols s⁽¹⁾ according to Equation (2).

A layer-mapping circuit 706 is configured to map the spread modulated data symbols s⁽¹⁾ from the transform-spreading circuit 504 onto a data stream for a first transmit beam (e.g., a main transmit beam) and for a second transmit beam (e.g., a diversity transmit beam, or “diversity beam”).

A precoding circuit 708 is configured to precode the mapped data stream of the spread modulated data symbols s⁽¹⁾ (Equation(2)).

A resource-mapping circuit 710 is configured to map the spread and precoded modulated data symbols to N subcarriers according to the following equations:

$${s}^{( 2 )} = \{ {s}_{1} , {s}_{2} , … , {s}_{M / 2} , 0 , … , 0 \} \qquad Equation ( 4 )$$

$${s}^{( 3 )} = \{ 0 , … , 0 , {s}_{M / 2 + 1} , … , {s}_{M} \} \qquad Equation ( 5 )$$

where “0” represents a null subcarrier, i.e., a subcarrier to which no spread and precoded modulated data symbol sₙ is mapped.

An RF beamformer circuit 712 includes a first RF beamformer 714a and a second (e.g., diversity) RF beamformer 714b configured to form the first transmit (e.g., main) beam from the first resource-mapped data stream on the first half of the N subcarriers of the first transmit beam as generated by the resource-mapping circuit 710 and to form the second transmit (e.g., diversity) beam from the second resource-mapped data stream on the second half of the N subcarriers of the second transmit beam as generated by the resource-mapping circuit. Each RF beamformer 714a and 714b generates first and second sets of signals (can be called “subsignals”) to be transmitted by the elements N_{x,y} of a transmit antenna array 716.

The transmit antenna array 716 is configured to generate (in the transmission medium) and to transmit the first transmit (e.g., main) beam and the second transmit (e.g., diversity) beam) in response to the first and second sets of signals from the RF beamformer circuit 712.

Still referring to FIG. 7 a receiver of a device (e.g., a base station gNB or WTRU) that receives the first and second (e.g., diversity) beams from the antenna array 716 can provide feedback to a GSFBC control-module circuit 718 of the transmit circuit 700, which is typically located in another device (e.g., another WTRU or another gNB), where the feedback can include one or more signal-related parameters such as channel-state information, error rate, and/or SNR at the receiver. In response to the feedback, the control-module circuit 718 is configured to control the transform-spreading circuit 704 to adjust the spreading transform to improve the quality of the received (at the receiver) signal(s) carrying the data symbols.

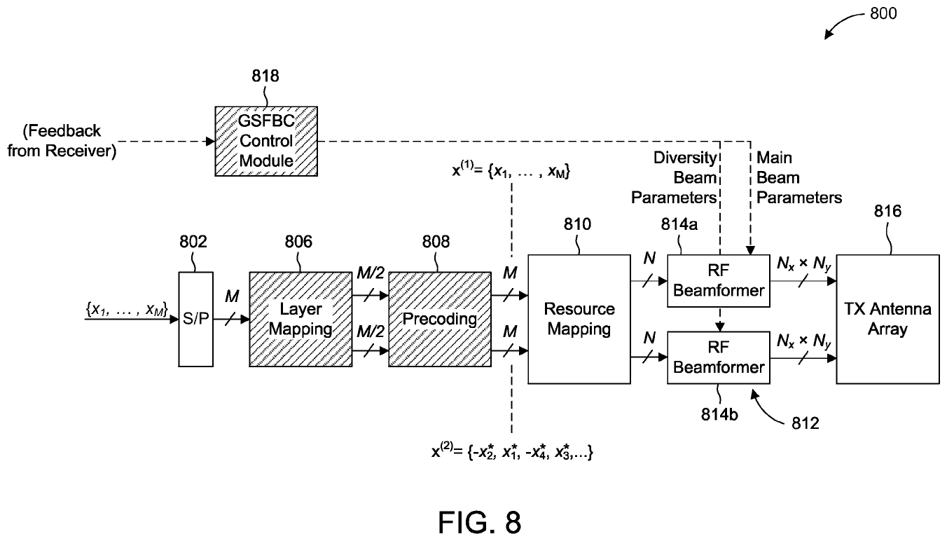

FIG. 8 is a diagram of a transmit-processing circuit 800 configured to perform transmit-processing steps for GSFBC encoding including generating a main beam and a diversity beam, according to an embodiment.

Referring to FIG. 8, in yet another embodiment, a method involves generation of a diversity beam with no Transform Spreading step, to improve resilience against beam misalignments and other impairments not caused by beam squint.

Still referring to FIG. 8, a series-to-parallel converter 802 is configured to convert the modulated data symbols x⁽¹⁾ of Equation (1) from a serial form to parallel form.

A layer-mapping circuit 806 is configured to map the modulated data symbols x⁽¹⁾ from the serial-to-parallel converter 802 onto a first data stream for a first transmit beam and onto a second data stream for a second transmit beam (e.g., a diversity transmit beam, or “diversity beam”).

A precoding circuit 808 is configured to precode the first mapped data stream of the modulated data symbols x⁽¹⁾ (Equation(1)) and to precode the second mapped data stream of the modulated conjugate data symbols x⁽²⁾ from the layer-mapping circuit 806 according to the following equations:

$${x}^{( 1 )} = \{ {x}_{1} , … , {x}_{M} \} \qquad Equation ( 6 )$$

$${x}^{( 2 )} = \{ - {x}_{2}^{*} , {x}_{1}^{*} , - {x}_{4}^{*} , {x}_{3}^{⋆} , … \} \qquad Equation ( 7 )$$

A resource-mapping circuit 810 is configured to map resources to the first precoded data stream and to the second precoded data stream, and to map the first and second precoded data streams onto N subcarriers, by allocating a first set of the N subcarriers to the precoded symbols of the first precoded data stream at a given frequency location, and by allocating a second set of the N subcarriers to the precoded symbols of the second precoded data stream at a same or different frequency location.

An RF beamformer circuit 812 includes a first (e.g., main) RF beamformer 814a and a second (e.g., diversity) RF beamformer 814b configured to form the first (e.g., main) transmit beam from the first resource-mapped data stream generated by the resource-mapping circuit 810 and to form the second (e.g., diversity) transmit beam from the second resource-mapped data stream generated by the resource-mapping circuit. Each RF beamformer 814a and 814b generates first and second sets of signals (can be called “subsignals”) to be transmitted by the antenna elements N_{x,y} of a transmit antenna array 816.

And a transmit antenna array 816 is configured to generate (in the transmission medium) and to transmit the first (e.g., main) transmit beam and the second (e.g., diversity) transmit beam in response to the first and second formed beams from the RF beamformer 812.

Still referring to FIG. 8, a receiver of a device (e.g., a base station gNB or WTRU) that receives the first (e.g., main) and second (e.g., diversity) beams from the antenna array 816 can provide feedback to a GSFBC control-module circuit 818 of the transmit circuit 800, which is typically located in another device (e.g., another WTRU or another gNB), where the feedback can include one or more signal-related parameters such as channel-state information, error rate, and/or SNR at the receiver. In response to the feedback, the control-module circuit 818 is configured to control the RF beamforming circuit 812 to adjust one or more parameters (e.g., beam half-power width, beam direction, and/or subcarriers on each beam) to improve the quality of the received (at the receiver) signal(s) carrying the data symbols.

Referring to FIGS. 3-8, without loss of generality, the channel responses of the beams involved in the examples are denoted by

$${h}^{( 1 )} = \{ {h}_{1}^{( 1 )} , … , {h}_{M}^{( 1 )} \} and {h}^{( 2 )} = \{ {h}_{1}^{( 2 )} , … , {h}_{M}^{( 2 )} \} ,$$

respectively, as functions of the subcarrier indices k=1, . . . , M. In some examples, the main (first) beam is generated according to legacy beam management procedures and the second beam is a diversity beam to improve resilience. In other examples, both the main and the second beams are the result of splitting a beam into two, each pointing at different directions in space and containing a respective subset of the subcarriers allocated for the user to reduce beam squint.

Embodiments of methods disclosed herein can be described by combinations of a few processing steps explained below, whose detailed steps for generation of a PDSCH channel in 5G NR are described below. The following example assumes that there is no SU-MIMO or MU-MIMO, but descriptions can be straightforwardly extended to incorporate these MIMO techniques:
1. Transform Spreading (performed, e.g., but a Transform-Spreading Circuit): this step (and/or circuit) applies a discrete transform operator [symbol] (x), x∈ [symbol] to the complex modulated data symbols such that it effectively spreads the symbols in the frequency domain. Data symbols correspond to complex constellation symbols conveying user data that are mapped to points in the complex plane according to a given constellation and modulation order, e.g., QPSK, M-QAM, etc. The Transform Spreading operation aims to yield a constant effective channel response to the transformed data symbols when there is significant uncertainty in the CSI at transmission, by averaging out the frequency variations caused by beam squint and/or other beam impairments so that the data symbols experience an approximately constant channel gain over frequency, which provides extra robustness against unpredictable impairments that can cause a frequency-dependent signal degradation. The output of this step (circuit) can be written as:

$${s}^{( 1 )} {=}^{△} \{ {s}_{1} , … , {s}_{M} \} = 𝒯 ( {x}^{( 1 )} ) = 𝒯 ( \{ {x}_{1} , … , {x}_{M} \} ) \qquad Equation ( 8 )$$

Examples of suitable Transform Spreading operators are, e.g., a Discrete Walsh-Hadamard Transform (DWHT), a Discrete Fourier Transform (DFT), a Discrete Cosine Transform (DCT), a Discrete Sine Transform (DST), a Discrete Wavelet Transform (DWT), and/or a Discrete Linear Chirp Transform (DLCT), among others.
2. Layer Mapping (performed, e.g., by a Layer-Mapping Circuit): the WTRU or other transmitter/receiver maps the transform-spread data symbols {s₁, . . . , s_{M}} to spatial layers according to the inputs for the subsequent steps. In GSFBC encoding, either one or two layers can be output from this block. As an example, if a main beam and a diversity beam are to be transmitted in two antenna ports then two layers are output from this block, while in single-beam transmission only one layer is output.
3. Precoding (performed, e.g., by a Precoding Circuit): applies a precoding operation to the data symbols on each of the beams involved in the transmission. This step (circuit) is responsible for the digital-beamforming step of hybrid-beamforming architectures. As an example, when a diversity beam is to be generated on transmission, an Alamouti space-frequency block-coding technique is applied comprising sign-reversed, complex conjugates per the following equation:

$${s}^{( 2 )} = \{ - {s}_{2}^{*} , {s}_{1}^{*} , - {s}_{4}^{*} , {s}_{3}^{*} , … , - {s}_{M}^{*} , {s}_{M - 1}^{*} \} \qquad Equation ( 9 )$$

In other cases where a diversity beam is not involved, the precoding step is mostly transparent and connects the Layer Mapping with the Resource Mapping steps.
4. Resource Mapping (performed, e.g., by a Resource-Mapping Circuit): the WTRU or other transmitter/receiver maps the sequence of complex precoded symbols to the resource elements of each beam. If two beams are generated, then the corresponding outputs of the Resource Mapping step feed the RF beamformers that perform analog beamforming of the beams for transmission. Resource Mapping frequency-multiplexes the data symbols allocated to data subcarriers with any additional control information present in the OFDM symbol allocated to control subcarriers (such as, in 5G NR, DM-RS, PT-RS, CSI-RS, PSS/SSS, or other control signals). As a result, data symbols are effectively spread over the space and frequency domains in the one or two beams for improved decoding robustness. Control symbols are, in contrast, maintained at their original positions so as to not impact any legacy procedures related to, e.g., data demodulation, CSI estimation, phase-noise compensation, etc. that leverage such control information. Examples of control signals include training symbols, reference signals, and pilot symbols.
5. GSFBC control module (circuit): this block controls the parameters used by GSFBC to perform either single-beam transmission or two-beam transmission. A WTRU or other wireless transmitter/receiver processor or controller executing this block selects the Transform Spreading function and/or provides the parameters for transmission of the diversity beam depending on the impairments and the feedback from the receiver, e.g., the severity of beam squint, the mobility, and/or whether misalignments are likely to occur because of imperfections.

Contrary to what happens in DFT-spread OFDM (DFT-s-OFDM) waveforms, the application of a DFT as a Transform Spreading function does not necessarily yield a single-carrier signal. In an embodiment, an aim of Transform Spreading is not to yield a single-carrier waveform (as in DFT-s-OFDM), but rather to spread the constellation data symbols in the frequency domain so as to balance the effective channel response seen by the symbols and to help compensate the generally unknown frequency-selective response caused by impairments. Thus, even if a transform operator based on DFT is applied in an OFDM signal, the result still is an OFDM signal where data symbols are first spread over frequency and then frequency-multiplexed with other control information at their intended frequency locations.

The diversity (e.g., second) transmit beam may be generated such that it possesses different characteristics than the main (e.g., first) transmit beam in either direction, beam width in the horizontal (H) plane, beam width in the vertical (V) plane, or a combination of these differences. This can be useful to cope with unpredictable impairments caused by beam misalignments including beam squint, and to render the channel responses h⁽¹⁾ and h⁽²⁾ different so that a statistical gain can be obtained. The diversity beam may thus have a wider beam width in the plane (H or V) where impairments are more likely to happen, such that detection is improved without impairing the beamforming gain of the main beam. An embodiment of this technique is discussed below.

GSFBC encoding can be regarded as a general means to provide extra diversity to beamformed transmissions with impairments: in the frequency domain by the spreading operation, and in the spatial domain by the diversity beam. Depending on the scenario of interest, one or the other can be selected to reinforce beam resilience on transmission, including splitting of the beams. As an example, in scenarios where misalignments are not expected to be significant, the diversity beam may be avoided and only the Transform Spreading step at the main beam may be sufficient to cope with beam squint, thus saving extra resources (see FIG. 6). Still as an example, in other cases, the beams can be split in different directions, each beam including Transform Spreading and only a respective half of the subcarriers to reduce the magnitude of beam squint if misalignments are not significant (see FIG. 7).

In yet other cases where beam squint is not significant but where beam misalignments may degrade performance, the Transform Spreading step may be avoided and the diversity (e.g., second) transmit beam may be generated without extra spreading of the complex symbols (see FIG. 8).

Both the Transform Spreading step and the characteristics of the diversity (e.g., second) transmit beam may be adapted to measurements performed at the receiver side, such as, e.g., detection performance statistics, CSI measurements, user velocity, or rate of change of the serving beam, as described below. Selection of the Transform Spreading function may also depend on the complexity and the capabilities of the receive side to support a specific subset of functions, as signaled to the transmitter by means of, e.g., a capabilities information message or any other control information.

The transmit-processing steps can be summarized as follows. The term “time-frequency resources” used below generally refers to the time instants and frequency subcarriers allocated for transmission of data or control information in a first or a second beam (if present), e.g., as signaled by a TRP. Without loss of generality, the term “resource allocations” can be used as a synonym of “time-frequency resources.”

A GSFBC control module gathers information about the set of available spreading functions (e.g., as obtained from higher-layer signaling), and any capabilities information from the receive side (e.g., as obtained from a capabilities information message), including, e.g., the supported spreading functions and the support of GSFBC with one or two beams.

Based on this, and on any beam-related scheduling information, and on measurements or reports of the link's performance degradation, the transmitter selects a spreading function and decides about the transmission and characteristics of a second beam (e.g., its H/V beam width, orientation, etc.).

The transmitter generates the complex constellation data symbols, applies a spreading function, and outputs the resulting complex data symbols to be mapped to data layers by a Layer Mapping module.

If a second (e.g., diversity) transmit beam is present, a Precoding module performs sign reversal and complex conjugation of the complex data symbols to be mapped to time-frequency resources for data in a second beam.

A Resource Mapping module maps the complex data symbols to time-frequency resources allocated for data in a first (e.g., main) transmit beam and in a second (e.g., diversity) transmit beam (if present), and maps any other control information (like, e.g., DM-RS, PT-RS, CSI-RS, PSS/SSS, or other control signals) to time-frequency resources allocated for control in a first beam and in a second beam (if present).

The transmitter transmits the first (e.g., main) beam and the second (e.g., diversity) beam (if present) by means of the RF beamformers and the TX Antenna Array, and also sends any control-signaling information containing information about the applied GSFBC encoding procedure.

Without loss of generality, the embodiments and examples herein can be applied to single-rank transmission but they also can be applied to spatially-multiplexed transmissions, by providing that each of the transmitted beams is accompanied by a suitable diversity beam (if applicable) according to one or more of the steps described above. It also may be possible to extend the proposed methods to multi-user MIMO scenarios provided that precoding includes MU-MIMO and that the acquired channel responses already incorporate the effects of any precoding for MU-MIMO applied on transmission to spatially multiplex users. Furthermore, although transmit circuits are described above in conjunction with FIGS. 5-8, corresponding receive circuits can be constructed as the duals of these transmit circuits.

In some embodiments, a WTRU receives GSFBC encoded signals.

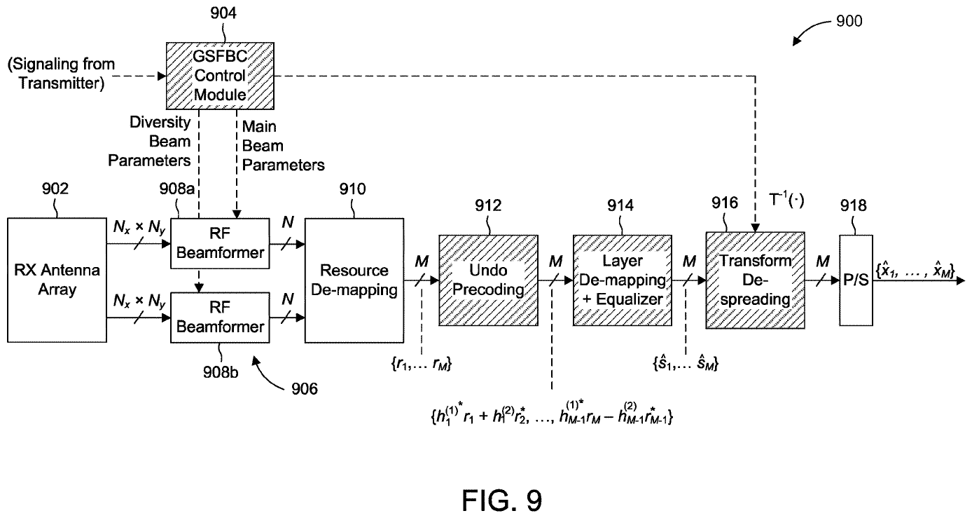

FIG. 9 is a block diagram of a receiver circuit 900 for GSFBC decoding according to an embodiment.

Referring to FIG. 9, detection of the diversity beam, when present, can leverage standard Alamouti decoding regardless of the application of Transform Spreading. Referring to FIG. 9, the receive processing required for detection and recovery of a main (e.g., first) and a diversity (e.g., second) beam of the disclosed GSFBC encoding procedure is shown. The received symbols from the main beam and the diversity beam, in this case, can be written as, after the resource de-mapping stage shown in FIG. 9:

$${r}_{1} = {h}_{1}^{( 1 )} {s}_{1} - {h}_{1}^{( 2 )} {s}_{2}^{*} + {w}_{1} , \qquad Equation ( 10 )$$

$${r}_{2} = {h}_{2}^{( 1 )} {s}_{2} + {h}_{2}^{( 2 )} {s}_{1}^{*} + {w}_{2} , \qquad Equation ( 11 )$$

$${r}_{M - 1} = {h}_{M - 1}^{( 1 )} {s}_{M - 1} - {h}_{M - 1}^{( 2 )} {s}_{M}^{*} + {w}_{M - 1} , \qquad Equation ( 12 )$$

$${r}_{M} = {h}_{M}^{( 1 )} {s}_{M} + {h}_{M}^{( 2 )} {s}_{M - 1}^{*} + {w}_{M} , \qquad Equation ( 13 )$$

where w₁, . . . , w_{M} are uncorrelated, circularly symmetric complex Gaussian variables that represent Additive White Gaussian Noise. The noise power is assumed to be equal to N₀ and the input SNR, γ, is defined as:

$$γ {=}^{△} \frac{𝔼 \{ {‖ {x}_{i} ‖}^{2} \}}{{N}_{0}} , \qquad Equation ( 14 )$$

where the expectation operator in the numerator runs over all possible transmitted symbols xᵢ.

If the receiver “knows” the channel state

$${h}_{1}^{( 1 )} , … , {h}_{M}^{( 1 )} and {h}_{1}^{( 2 )} , … , {h}_{M}^{( 2 )}$$

(e.g., from suitable demodulation reference signals or other pilot information), then the symbols can be recovered at the Undo Precoding Circuit (stage) 912 in FIG. 9 in pairs by means of standard Alamouti processing. Assuming that the channel responses do not change significantly over consecutive indices,

$${h}_{1}^{( 1 , 2 )} ≃ {h}_{2}^{( 1 , 2 )}$$

and:

$${h}_{1}^{( 1 ) *} {r}_{1} + {h}_{1}^{( 2 )} {r}_{2}^{*} ≃ {\underbrace{( {‖ {h}_{1}^{( 1 )} ‖}^{2} + {‖ {h}_{1}^{( 2 )} ‖}^{2} ) {s}_{1}}}_{signal} + {\underbrace{{h}_{1}^{( 1 ) *} {w}_{1} + {h}_{i}^{( 2 )} {w}_{2}^{*}}}_{noise} , \qquad Equation ( 15 )$$

$${h}_{1}^{( 1 ) *} {r}_{2} - {h}_{1}^{( 2 )} {r}_{1}^{*} ≃ {\underbrace{( {‖ {h}_{1}^{( 1 )} ‖}^{2} + {‖ {h}_{1}^{( 2 )} ‖}^{2} ) {s}_{2}}}_{signal} + {\underbrace{{h}_{1}^{( 1 ) *} {w}_{1} + {h}_{i}^{( 2 )} {w}_{2}^{*}}}_{noise} , \qquad Equation ( 16 )$$

This process can continue in pairs to show that proper estimates of the symbols ŝᵢ can be obtained after a combined Layer De-mapping and Equalization (circuit/stage 914) as shown in FIG. 9. The Layer De-mapping process would forward the symbols transparently to a proper equalization stage, e.g., a Linear Minimum Mean-Squared Error (LMMSE) equalizer or a Decision-Feedback Equalizer (DFE), whose inputs have an effective channel gain approximately equal to

$${‖ {h}_{i}^{( 1 )} ‖}^{2} + {‖ {h}_{i}^{( 2 )} ‖}^{2} .$$

The post-detection SNR is given by

$$( {‖ {h}_{i}^{( 1 )} ‖}^{2} + {‖ {h}_{i}^{( 2 )} ‖}^{2} ) γ ,$$

which can be taken into account during the equalization step.

In the cases where Transform Spreading is applied on transmission, the symbols {ŝ₁, . . . , ŝ_{M}} obtained after equalization may undergo a Transform de-Spreading step to yield estimates of the original symbols {\hat{x}₁, . . . , \hat{x}_{M}}, i.e.:

$$\{ {\hat{x}}_{1} , … , {\hat{x}}_{M} \} = {𝒯}^{- 1} \{ ( {\hat{s}}_{1} , … , {\hat{s}}_{M} ) \} . \qquad Equation ( 17 )$$

The existence of the inverse transform function [symbol] is granted by the orthogonality of the operator [symbol] , which in a finite-dimensional space [symbol] ensures that the inverse exists and can be represented by the transpose of the matrix representation of [symbol] .

A combination of the above steps can be applied on the received signal depending on whether a diversity beam is present or not, and whether it is affected on transmission by Transform Spreading along with the main beam.

Similar to the transmit processing steps, a GSFBC control module would configure the appropriate parameters of the main beam, the diversity beam (if present), and the Transform de-spreading stages at the receiver, according to the signaling obtained from the transmitter side.

Still referring to FIG. 9, the structure and operation of the receiving circuit 900 (e.g., the receive processing steps for GSFBC decoding) are described as follows, assuming that both a main (e.g., first) receive beam and a diversity (e.g., second) receive beam are received, according to an embodiment.

A receive antenna array RX 902 having Nx×Ny antenna elements is configured to receive a main (first) receive beam and a diversity (second) receive beam both carrying data symbols where at least one of the beams carries data symbols to which one or more transform-spreading functions were applied at the transmitter.

A GSFBC control module 904 is configured to provide information about the applied transform-spreading functions and the resource allocations of the main receive beam and the diversity receive beam, as obtained, e.g., via control signaling from the transmitter, and is also configured to provide information regarding parameters of the main and diversity beams.

An RF beamformer circuit 906 includes a first RF beamformer 908a configured, in response to information from the control module 904 regarding one or more parameters of the main beam and/or one or more parameters of the diversity beam, to form the main beam and a second RF beamformer 908b configured to form the diversity beam from the signals received from the Nx×Ny antenna elements of the receive antenna array 902.

A Resource De-mapping circuit 910 is configured to obtain the received control symbols and a first set of received data symbols resulting from the superposition of the main beam and the diversity beam according to the following equation:

$$\{ {r}_{1} , … , {r}_{M} \} \qquad Equation ( 18 )$$

An Undo Precoding circuit 912 is configured to undo precoding of the data symbols performed at the transmitter by combining a first set of complex received data symbols and their sign-reversed and complex-conjugates, weighted by the channel responses of a first and a second beam, to yield a second set of received data symbols according to the following equation:

$$\{ {h}_{1}^{( 1 ) *} {r}_{1} + {h}_{1}^{( 2 )} {r}_{2}^{*} , … , {h}_{M - 1}^{( 1 ) *} {r}_{M} - {h}_{M - 1}^{( 2 )} {r}_{M - 1}^{*} \} \qquad Equation ( 19 )$$

A Layer Demapping+Equalizer Circuit 914 is configured to step transparently forward the second set of received data symbols to an equalizer stage that yields a set of transform-spread equalized data symbols according to the following equation:

$$\{ {\hat{s}}_{1} , … , {\hat{s}}_{M} \} \qquad Equation ( 20 )$$

A Transform De-Spreading Circuit 916 is configured, in response to transmitter transform-spreading information from the control module 904, to apply an inverse of the transform spreading function used in transmission over the equalized data symbols to yield suitable estimates of the originally transmitted complex constellation data symbols.

And a parallel-to-serial converter 918 is configured to convert the parallel data stream from the Transform De-Spreading Circuit 916 to a serial data stream of the estimated (recovered) data symbols (e.g., the estimates of the original transmitted data symbols) according to the following equation:

$$\{ {\hat{x}}_{1} , … , {\hat{x}}_{M} \} \qquad Equation ( 21 )$$

Without loss of generality, the receive-circuit 900 operations herein consider single-rank transmission but they can also be applied to spatially multiplexed transmissions, e.g., in single-user MIMO or multi-user MIMO scenarios.

Still referring to FIG. 9, other embodiments of the receive circuit 900 are contemplated. For example, if the receive circuit 900 receives a main beam and a diversity beam having no transform spreading, then the Transform De-Spreading Circuit 916 can be omitted from the circuit 900 or the function or operation of the circuit 916 can be suspended. Likewise, if the receive circuit 900 receives only a main beam, then the RF beamformer circuit 906 can be omitted from the circuit 900 or the function or operation of the circuit 906 can be suspended. Furthermore, a transmitter circuit compatible with and/or suitable for the receive circuit 900 can be a dual of the receive circuit.

Referring to FIGS. 4-9, if the diversity beam were identical to the main beam, then the resulting 3-dB SNR gain after Alamouti decoding would come at the expense of 3-dB more transmit power, hence bringing no net gain. To obtain a net gain, the diversity beam may be generated (at both the transmitter circuit and at the receiver circuit) according to different guidelines relative to the guidelines according to which the main beam is generated. Examples of generating the diversity beam according to different guidelines include:
If impairments from beam misalignments are significant, then the diversity beam may be generated such that it has a wider beam width in the plane (H or V) where random movements are likely to be more frequent during communications. If movements are completely random, or no particular direction dominates in the result, then the diversity beam may be widened in both H and V planes to reinforce detection in whatever circumstances.
Widening of the beam in the H or V plane can be achieved by exciting fewer RF antennas and/or antenna elements in the corresponding plane than usually employed in connected mode for the main beam. If needed, losses resulting from the lower beamforming gain may be compensated by feeding the Power Amplifiers (PA) with higher per-PA transmit powers. In other cases, the diversity beam may have a lower transmit power while still bringing extra robustness to the main beam without compromising coverage. Generation of wider beams may be done in accordance with a scheduler to avoid eventual conflicts with beams in use for other users, potentially requiring that the digital precoding stage applies further precoding to minimize inter-user interferences when spatially multiplexing the signals.
If movements (of the transmitter and/or receiver relative to each other) are particularly predictable, the transmitter may select one of the directions immediately adjacent to the main beam in the transmitter's grid of beams with higher chances of reception, provided that it is not reserved to another user.
If beam squint is not significant but impairments from beam misalignments are present, or there is blockage of the line-of-sight direction, the Transform Spreading step may be omitted and the diversity beam may be generated with the characteristics (orientation and H/V beam width) that can best reinforce detection. This case can be applied when very narrow beams at high frequencies make it difficult for the beam management scheme to successfully track a WTRU's movement. In some cases, the diversity beam may point towards a completely different direction than the main beam to help overcome eventual obstacles in the line-of-sight direction. In such scenarios the diversity beam may or may not have a higher beam width depending on the need to improve resilience against misalignments.
In all the above cases, the diversity beam can be generated by a different TRP in a multi-TRP scenario.

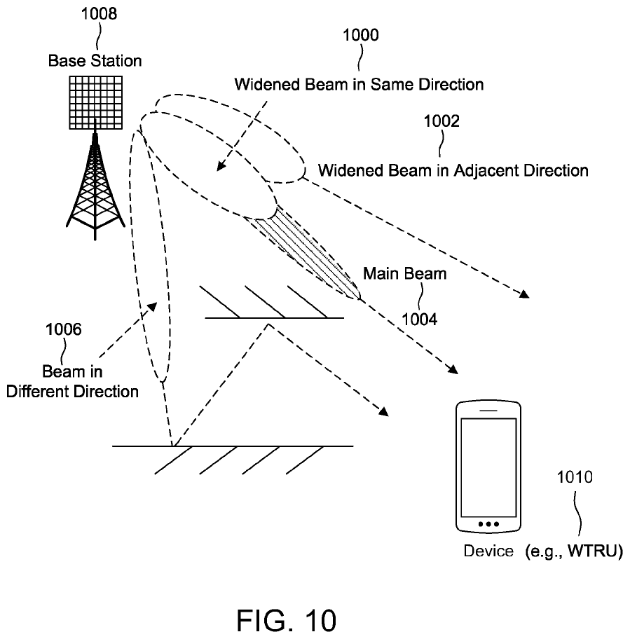

FIG. 10 is a diagram illustrating possibilities for a diversity beam showing examples of widened beams 1000, 1002 in the same or in an adjacent direction with respect to a main beam 1004, and a diversity beam 1006 in a different direction, in a single-TRP scenario, according to an embodiment.

FIG. 10 illustrates embodiments of these possibilities for the case of a single TRP.

Still referring to FIG. 10, selection of a diversity beam may be done by the transmitter 1008 (e.g., the base station) in a way that is transparent to the receiver 1010 (e.g., a WTRU). In some examples, the transmitter may not signal the characteristics of the diversity beam to the receiver, which can simply obtain the combined data streams from both beams and perform proper signal decoding. Only the channel state can be acquired by the receiver at the main beam and the diversity beam, e.g., by means of suitable reference signals or other pilot information. However, in some examples, the transmitter may also signal information (e.g., the indices or any other similar identifiers) of one or more Quasi-Co-Located (QCL) source signals to the receiver such that the receiver may estimate some parameters (e.g., related to any of time, frequency, and/or spatial characteristics) based on the source signals and apply them for signal reception of the main and/or diversity beam.

As was also explained above in conjunction with FIG. 3, a second beam may be generated because of splitting the main beam into two, each pointing towards a different direction and carrying a respective half of the subcarriers to reduce the beam-squint effect. The characteristics of the beams in this case are determined by a GSFBC control module as explained above.

A request to activate GSFBC encoding can be triggered by the receiver upon fulfilment of certain events. GSFBC encoding also can be configured, activated, and/or triggered by the transmitter upon fulfilment of certain events possibly aided by measurements reported by the receiver. Such events and measurements can be and can include:
A difference in the magnitude of the CSI measurements at the farthest and the nearest subcarriers with respect to the DC subcarrier above a threshold (indicative of beam squint). Such difference may be measured by the transmitter, or reported by the receiver, after averaging over multiple slots, TTIs, or radio frames, to account for eventual channel variations in time and frequency.
User velocity, or rate of change of the serving beam, above a threshold (indicative of channel aging and/or mobility), as measured by the transmitter or reported by the receiver.
A lower-rate modulation and coding scheme required to maintain a given detection performance in response to the ACK/NACK indications sent by the receiver (indicative of a performance degradation not resolved by the legacy beam management and/or link adaptation procedures), as measured by the transmitter or reported by the receiver.
A mismatch between the CSI measurements performed on the reference signals for beam management, e.g., CSI-RS or other pilot information, and the demodulation reference signals for data detection, e.g., DM-RS or other pilot information (indicative of a performance degradation not resolved by the legacy beam management and/or link adaptation procedures), as measured by the receiver.
Rms error magnitude of CSI measurements above a threshold (indicative of impairments, or imprecision, of the acquired CSI), as measured by the transmitter or reported by the receiver.
Performance statistics (such as BER, BLER, ACK/NACK statistics, etc., averaged over multiple slots) above a fourth threshold (indicative of a performance degradation not resolved by the legacy beam management and/or link adaptation procedures), as measured by the transmitter or reported by the receiver.

Other drivers may also trigger the activation of GSFBC, or a request to activate GSFBC, depending on implementation needs. Measurements performed at the receiver side may be reported to the transmitter upon fulfilment of some condition, e.g., their level exceeding, or falling below, a threshold whose value may be sent by the transmitter in a configuration message. The receiver can also report other measurements, or combinations of measurements, including a request to trigger GSFBC encoding of the beams if deemed appropriate, to help the transmitter in the assessment of a potential activation of GSFBC. The transmitter may analyze these reports for activation of GSFBC together with other factors like, e.g., the number of active beams vs. the maximum number of beams, the power consumption, the transmit power headroom, and others.

Measurement reports from the receiver can be sent on a shared channel, e.g., physical uplink control or shared channel, and can be configured by the transmitter in terms of, e.g., the types of quantities to report, and whether reports are to be sent in a periodic, semi-persistent, aperiodic, on-demand, or event-triggered fashion, including proper configuration of the events that must trigger a report from the receiver.

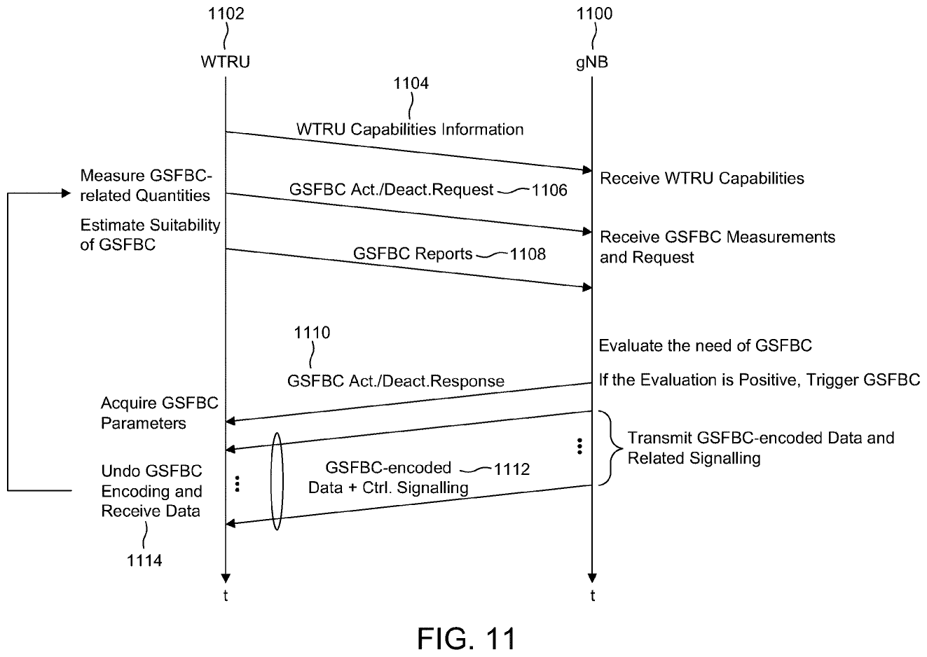

FIG. 11 is a diagram that illustrates a control-signaling mechanism involved in the activation of GSFBC by the transmitter upon a request from the receiver, according to an embodiment. Without loss of generality, a gNB 1100 in FIG. 11 can be the transmitting entity and a WTRU 1102 can be the receiving entity. At 1104, the WTRU 1102 first reports its capabilities to the gNB 1100 so that the gNB is aware of any constraints related to GSFBC support. At 1106, the gNB 1100, upon reception of a request to activate/deactivate GSFBC from the WTRU 1102, may assess the suitability of GSFBC depending on, e.g., link performance, number of active beams vs. maximum number of beams at the transmitter, or available power headroom, among others. The request from the WTRU 1102 may include, at 1108, reported quantities of the link's performance degradation, e.g., CSI measurements, rms error magnitude of CSI measurements, user velocity, performance statistics, modulation and coding scheme, and/or any other suitable indicators to assist the gNB 1100. If the gNB 1100 decides, at 1110, to activate GSFBC, it may signal some GSFBC-related parameters to the WTRU by means of, e.g., suitable Downlink Control Indicator (DCI) signaling as part of the Physical Downlink Control Channel (PDCCH), higher-layer Radio Resource Control (RRC) signaling, or through MAC CE commands. At 1112, GSFBC-encoded data is, therefore, generated by the gNB 1100 containing one or two beams to improve beam resilience as described above, and the gNB sends this data and also sends control signals to the WTRU 1102. And at 1114, the WTRU 1102 may, as part of the described loop, undo the GSFBC decoding to recover data transmitted from the gNB 1100, measure GSFBC-related quantities, estimate suitability of GSFBC for the current conditions, and, if the WTRU requests activation of GSFBC, perform the operations at 1104, 1106, and 1108, receive an activation response from the gNB at 1110, and acquire GSFBC parameters from the gNB 1100 at 1112.

The control information conveyed by the transmitter (e.g., gNB 1100 at 1112) may include an indication of GSFBC encoding, and/or an index to the applied Transform Spreading function among a set of functions contained in a predefined codebook. The receiver (e.g., WTRU 1102) also may perform blind detection of the actual transform in use without an explicit indication from the transmitter. The transform may also be statically or semi-statically signaled by RRC configuration messages.

The characteristics of the diversity beam (or the second beam in a beam-splitting scenario), e.g., its H/V beam width or its orientation, may be transparent to the receiver and its parameters need not be exposed to enable detection. Only the channel state information (CSI) is acquired by the receiver to combine the symbols from the main beam and the diversity beam according to the procedure described above, if needed. The main beam may be selected and updated according to conventional beam-management techniques regardless of the activation of the diversity beam. In other cases, the gNB 1100 also may signal information of one or more QCL source signals to the WTRU 1102 such that the WTRU may estimate some parameters of the main and/or diversity beams.

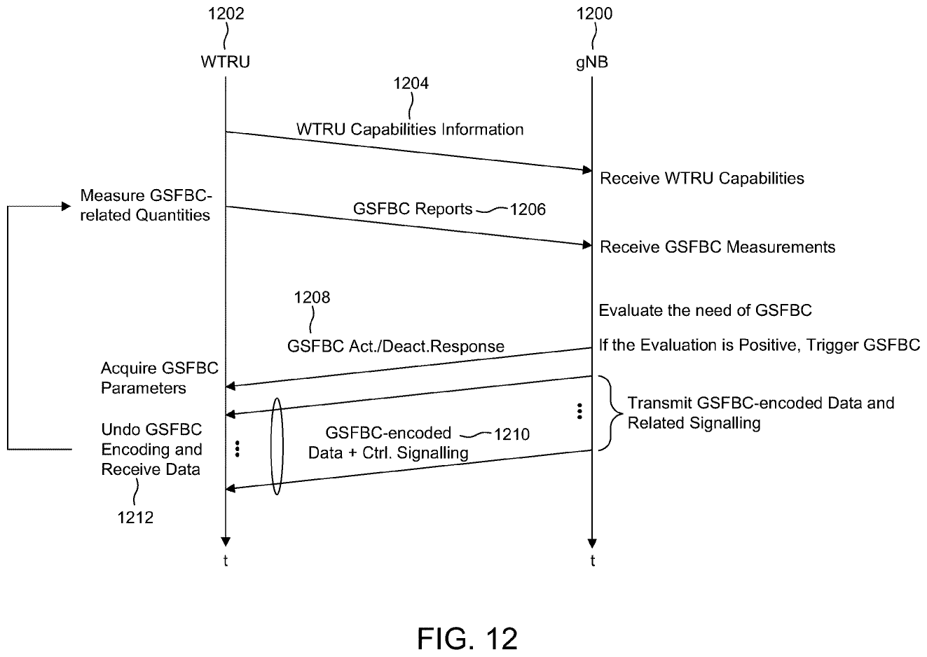

The transmitter (e.g., gNB 1100) may also trigger GSFBC without a request from the receiver (e.g., WTRU 1102), e.g., as part of a pre-defined rule or hard-coded by the implementation, because the transmitter “knows” the amount of beam squint or other impairments impacting reception, or because of insufficient knowledge (or accuracy) of the CSI. This is illustrated in the exemplary flow chart of FIG. 12 where a transmitting gNB 1200 triggers the activation of GSFBC without a request from the receiving WTRU 1202, but with the aid of the feedback reports from it.

FIG. 12 is a diagram that illustrates a control-signaling mechanism involved in the activation of GSFBC by the transmitter in the absence of a request from the receiver, according to an embodiment. Without loss of generality, a gNB 1200 can be the transmitting entity and a WTRU 1202 can be the receiving entity. At 1204, the WTRU 1202 first reports its capabilities to the gNB 1200 so that the gNB is aware of any constraints related to GSFBC support. At 1206, the WTRU 1202 sends the gNB 1200 one or more GSFBC reports that may include quantities of the link's performance degradation, e.g., CSI measurements, rms error magnitude of CSI measurements, user velocity, performance statistics, modulation and coding scheme, and/or any other suitable indicators to assist the gNB 1200. In response to this report, the gNB 1200, may assess the suitability of GSFBC depending on, e.g., link performance, number of active beams vs. maximum number of beams at the transmitter, or available power headroom, among others. If the gNB 1100 decides, at 1208, to activate GSFBC, it may signal some GSFBC-related parameters to the WTRU 1202 by means of, e.g., suitable Downlink Control Indicator (DCI) signaling as part of the Physical Downlink Control Channel (PDCCH), higher-layer Radio Resource Control (RRC) signaling, or through MAC CE commands. At 1210, GSFBC-encoded data is, therefore, generated by the gNB 1200 containing one or two beams to improve beam resilience as described above, and the gNB sends this data and also sends control signals to the WTRU 1202. And at 1212, the WTRU 1202 may, as part of the described loop, undo the GSFBC decoding to recover data transmitted from the gNB 1200, measure GSFBC-related quantities, estimate suitability of GSFBC for the current conditions, and perform the operations at 1204, 1206, and 1208 and acquire GSFBC parameters from the gNB 1200 at 1210.

Referring to FIGS. 11-12, in an embodiment, changes to 5G NR specifications include using the transmission of GSFBC-encoded signals in the downlink. Similar steps can be followed in the uplink and/or for application to other channels, if suitable.

The WTRU “assumes” that the PDSCH channel, after the scrambling and modulation steps, undergoes further layer mapping and precoding to generate GSFBC-encoded symbols according to the changes described herein. In order to better fit in existing 3GPP physical-layer blocks, one or more of the Transform Spreading steps (performed by a Transform-Spreading Circuit) described above are included herein as part of Layer Mapping (performed by a Layer-Mapping Circuit).

Without loss of generality, changes are described for the case of up to two layers transmitted by means of up to two antenna ports, and one codeword. The results can be easily generalized to a higher number of layers and/or antenna ports in SU-MIMO and MU-MIMO.

The WTRU “assumes” that complex-valued modulation symbols for codeword 0 are mapped onto 1 or 2 layers for transmission. Denoting by d⁽⁰⁾(i) the complex modulated symbols in codeword 0 that are output from the Modulation Mapper, with i=0,1, . . . ,

$${M}_{s y m b}^{( 0 )} - 1 ,$$

a codeword-to-layer mapping operation is performed as described below to yield the symbols at the output of the Layer-Mapping Circuit. In this example,

$${M}_{symb}^{( 0 )}$$

is the number of complex modulated symbols in codeword 0,

$${M}_{symb}^{layer}$$

is the number of symbols in each layer, and t⁽⁰⁾(j)= [symbol] {d⁽⁰⁾(i)} denotes the output of a discrete orthogonal transform [symbol] applied over the complex modulated symbols d⁽⁰⁾(i), with j=0,1, . . . ,

$${M}_{symb}^{( 0 )} - 1.$$

A higher-layer parameter DLTransformSpreading is introduced to control whether a Transform Spreading Circuit applies a Transform Spreading on the beams, and a higher-layer parameter DLTransmitDiversity is also introduced to control whether a second (diversity) beam is generated, as follows.
1. If DLTransformSpreading is set to 1, then:
   If DLTransmitDiversity is set to 1, then the WTRU “assumes” that 2 layers are used for transmission of the physical channel over 2 antenna ports as follows:

$${x}^{( 0 )} ( i ) = {t}^{( 0 )} ( 2 i ) , \qquad Equation ( 22 )$$

$${x}^{( 1 )} ( i ) = {t}^{( 0 )} ( 2 i + 1 ) , \qquad Equation ( 23 )$$

$$where i = 0 , 1 , … , {M}_{symb}^{layer} - 1 with {M}_{symb}^{layer} = {M}_{symb}^{( 0 )} / 2. \qquad Equation ( 24 )$$

If DLTransmitDiversity is set to 0, then the WTRU “assumes” that 1 layer is used for transmission of the physical channel over 1 antenna port as follows:

$${x}^{( 0 )} ( i ) = {t}^{( 0 )} ( i ) , \qquad Equation ( 25 )$$

$$where i = 0 , 1 , … , {M}_{symb}^{layer} - 1 with {M}_{symb}^{layer} = {M}_{symb}^{( 0 )} .$$

2. If DLTransformSpreading is set to 0, then:
   If DLTransmitDiversity is set to 1, then the WTRU “assumes” that 2 layers are used for transmission of the physical channel over 2 antenna ports as follows:

$${x}^{( 0 )} ( i ) = {d}^{( 0 )} ( 2 i ) , \qquad Equation ( 26 )$$

$${x}^{( 1 )} ( i ) = {d}^{( 0 )} ( 2 i + 1 ) ,$$

$$where i = 0 , 1 , … , {M}_{symb}^{layer} - 1 with {M}_{symb}^{layer} = {M}_{symb}^{( 0 )} / 2 ,$$

If DLTransmitDiversity is set to 0, then the WTRU “assumes” that 1 layer is used for transmission of the physical channel over 1 antenna port as follows:

$${x}^{( 0 )} ( i ) = {d}^{( 0 )} ( i ) , \qquad Equation ( 27 )$$

$$where i = 0 , 1 , … , {M}_{symb}^{layer} - 1 and {M}_{symb}^{layer} = {M}_{symb}^{( 0 )} .$$

The transform [symbol] (·) can be described unambiguously by an index in a pre-defined codebook of Transform Spreading functions configured by higher layers.

In an embodiment, precoding for GSFBC is used only in combination with layer mapping for GSFBC, although this is not a requirement. The precoding operation is described for one or two antenna ports depending on the value of the higher-layer parameter DLTransmitDiversity.
1. If DLTransmitDiversity is set to 1, then the WTRU “assumes” that the precoder's output y(i)=[y⁽⁰⁾(i) y⁽¹⁾(i)]^{T}, i=0,1, . . . ,

$${M}_{symb}^{ap} - 1$$

is described by the following equations for transmission over 2 antenna ports:

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) \\ Re ( {x}^{( 1 )} ( i ) \\ Im ( {x}^{( 0 )} ( i ) \\ Im ( {x}^{( 1 )} ( i )\end{matrix} ] , \qquad Equation ( 28 )$$

for i=0,1 . . . ,

$${M}_{symb}^{layer} - 1$$

with

$${M}_{symb}^{ap} = 2 {M}_{symb}^{layer} ,$$

where

$${M}_{symb}^{ap}$$

is the number of precoded symbols for each antenna port. The factor 1/\sqrt{2} preserves transmission power so that it is not increased by GSFBC encoding.
2. If DLTransmitDiversity is set to 0, then the WTRU “assumes” that the precoder's output y(i)=y⁽⁰⁾(i), i=0,1, . . . ,

$${M}_{symb}^{ap} - 1$$

is described by the following equation:

$${y}^{( 0 )} ( i ) = {x}^{( 0 )} ( i ) , \qquad Equation ( 29 )$$

with

$${M}_{symb}^{ap} = {M}_{symb}^{layer} .$$

Symbols at the Precoding Circuit's output are then mapped to appropriate antenna ports following a conventional antenna-port mapping procedure suitable for 5G NR.

The previously described embodiments and examples may be better understood through analysis of the exemplary embodiments described below.

Performance of GSFBC encoding is shown by means of suitable link-level simulations that model the effects of beam squint and/or beam misalignments. A Transform Spreading step based on the Discrete Walsh-Hadamard Transform (DWHT) is disclosed in this example. Beam-squint effect is modelled in a rectangular Uniform Planar Array (UPA) comprising N_{H}×N_{V} antennas as a function of the carrier frequency f_{c} and the user bandwidth B, with N₁₁=N_{V}. The diversity beam has a widened beamwidth in both H and V planes by exciting half of the antennas in each direction, i.e., N_{H}/2×N_{V}/2 antennas. Both the main beam and the diversity beam carry half the total transmit power to not bias the bit signal-to-noise ratio, Eb/N0.

Impact from beam misalignments is modelled by randomly changing the instantaneous elevation φ and azimuth θ in every time slot according to uniform distributions, respectively given by φ=U[φ_{F}(1−ϵ), φ_{F}(1+ϵ)] and θ=U[θ_{F}(1−ϵ), θ_{F}(1+ϵ)], where φ_{F} and θ_{F} respectively denote the focus direction in elevation (Vertical V) and azimuth (Horizontal H), and ϵ is the maximum relative deviation. Both the main and the diversity beam points are in the same instantaneous direction (φ, θ) in every time slot and suffer from beam squint according to their respective parameters. As no inter-carrier interference (ICI) is due (at least in this example) to beam misalignments (which are modelled to change the signal's level in every time slot, not at an intra-slot level), the rate of change of the beam's orientation does not affect performance but only impacts the simulation time needed to get statistically representative results.

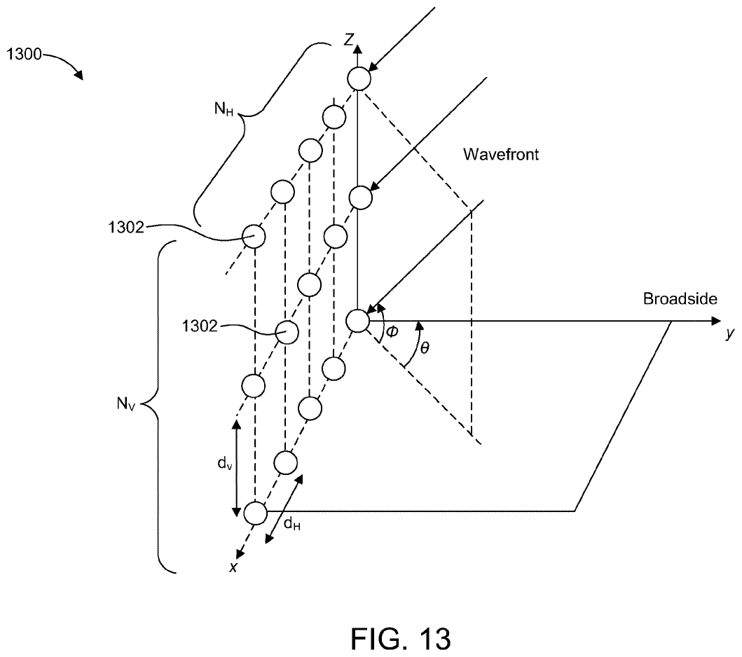

FIG. 13 is a diagram of a geometrical arrangement of an array 1300 of antennas 1302 used for simulations with a UPA in the X-Z plane, according to an embodiment.

The following table summarizes the simulation parameters.

TABLE 1
Simulation assumptions

| Parameter | Value | Comments |
|---|---|---|
| Channel model | AWGN | Channel's frequency selectivity is considered to |
| | | be negligible because of beamforming |
| Channel estimation | Ideal | Genie channel estimator with ideal noise |
| | | estimator |
| Equalizer | LMMSE | |
| Numerology | Δf = 7680 kHz, | Obtained by extension of current 5G NR |
| | N = 4096 | numerology up to THz bands with μ = 9 |
| Carrier frequency, f_{c} | 200 GHz | |
| Number of user | 1024 and 2048 | |
| subcarriers M | | |
| UPA configuration | N_{H} × N_{V} antennas with | |
| | N_{H} = N_{V} = 100 and 64 | |
| User bandwidth, B | 7.84 GHz and 15.68 GHz | Simulated combinations (M(sc), B(GHz), N_{H}) |
| | | and maximum SNR loss from beam squint: |
| | | (1024, 7.84, 100): 6.5 dB |
| | | (2048, 15.68, 64): 11.3 dB |
| Eb/N0 | From 0 to 51 dB in 3 dB- | |
| | steps | |
| Modulation order | QPSK and 16QAM | |
| Transform Spreading | Discrete Walsh-Hadamard | |
| | Transform (DWHT) | |
| FEC coding | No | |
| Focus angle | (φ_{F}, θ_{F}) = (30°, 30°) | Direction of maximum radiation in absence of |
| | | beam squint |
| ε | 0, 0.05, 0.1 | Maximum relative deviation in azimuth and |
| | | elevation |
| BER stopping condition | 200 erroneous slots | Simulation stops when at least 200 slots of 14 |
| | | DFT-s-OFDM symbols each are received with |
| | | errors |

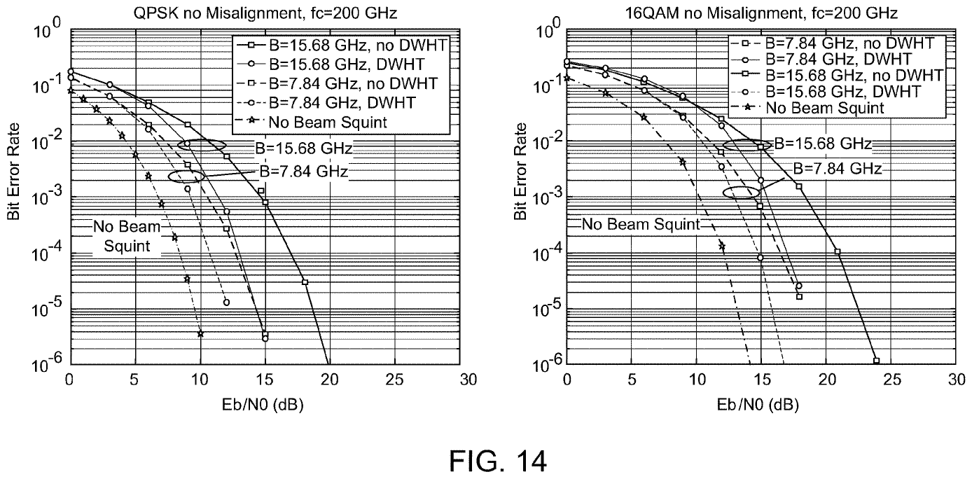

The results are shown in FIGS. 14, 15, and 16.

FIG. 14 is a Bit Error Rate vs. Bit SNR plot of results of simulations using the geometrical arrangement of antennas of FIG. 13 with beam squint and no beam misalignment, f_{c}=200 GHz, B=7.84 GHz and 15.68 GHz, in QPSK (left plot) and 16QAM (right plot), according to an embodiment.

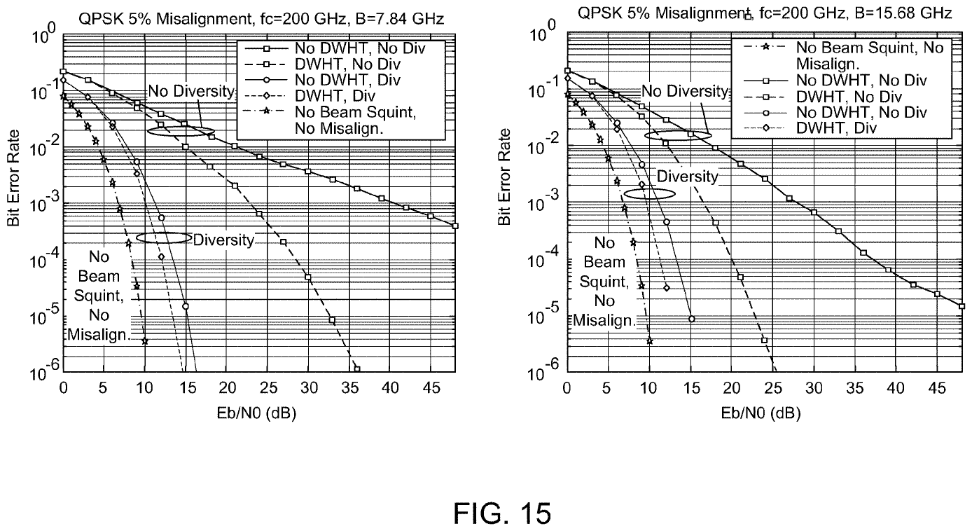

FIG. 15 is a Bit Error Rate vs. Bit SNR plot of results of simulations using the geometrical arrangement of antennas of FIG. 13 with beam squint, random beam misalignment up to ±5% of the ideal direction, QPSK, f_{c}=200 GHz, B=7.84 GHz (left-hand plot) and 15.68 GHz (right-hand plot), according to an embodiment.

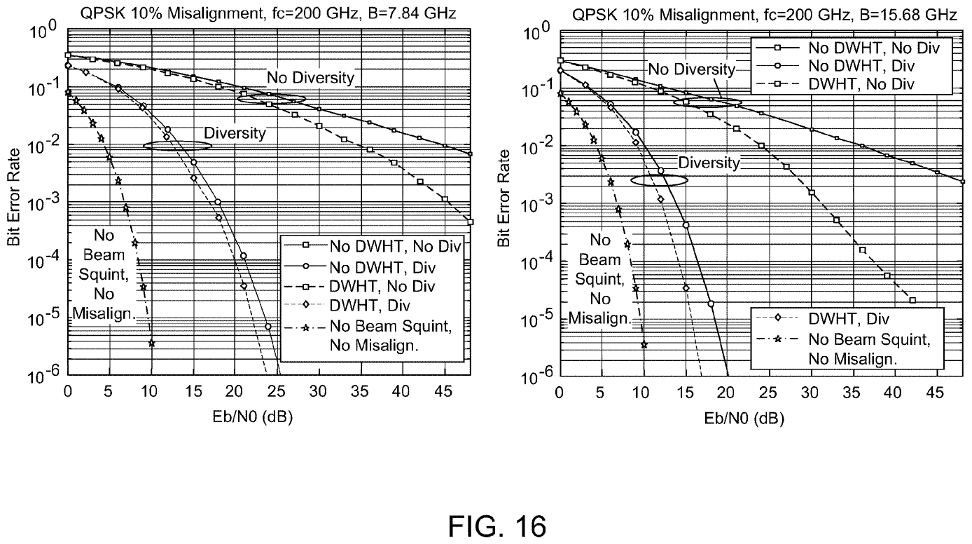

FIG. 16 is a Bit Error Rate vs. Bit SNR plot of results of simulations using the geometrical arrangement of antennas of FIG. 13 with beam squint, random beam misalignments of up to ±10% of the ideal direction, QPSK, f_{c}=200 GHz, B=7.84 GHz (left-hand plot) and 15.68 GHz (right-hand plot), according to an embodiment.

With no beam misalignments (FIG. 14), the Transform Spreading step improves the uncoded bit error rate by an amount that increases with the magnitude of beam squint (i.e., with the user's bandwidth). The remaining Eb/NO gap with respect to the ideal curve (labeled as “no beam squint” in FIG. 14) comes from the average SNR loss incurred by beam squint, that in practice can be compensated by a lower coding rate when using forward error correction.

With random beam misalignments up to ±5% and ±10% of the ideal direction (FIG. 15 and FIG. 16 respectively), best results can be obtained by combining DWHT with diversity. The presence of DWHT improves results even in absence of diversity, especially for the larger user bandwidths (15.68 GHz) and smaller beam misalignments (5%). This is evidence that proves that Transform Spreading is especially useful to cope with and to compensate for beam squint while diversity brings robustness to beam misalignments. The combination of the two can get close in performance to the ideal case without beam squint or misalignments (˜3 dB for ϵ=0.05, 12 dB for ϵ=0.1). Notice that misalignments up to ±10% of the beam's direction are unrealistically high and are only disclosed here to illustrate the performance of DWHT and diversity techniques when faced with very challenging conditions.

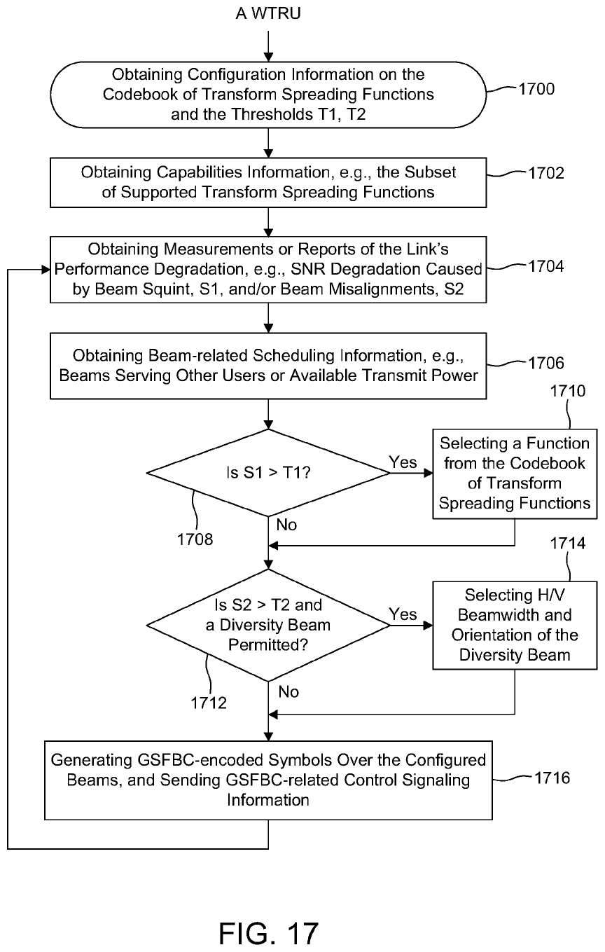

FIG. 17 is a flow diagram for generating transmission signals based on Generalized Space-Frequency Block Coding (GSFBC), according to an embodiment.

As exemplified in FIG. 17, the flow diagram represents a first WTRU or set of first WTRUs transmitting wireless signals to a second WTRU characterized by:
At 1700, obtaining configuration information on the codebook of Transform Spreading functions and thresholds T1 and T2;
At 1702, obtaining capabilities information containing, e.g., the subset of Transform Spreading functions supported by the second WTRU or any constraints related to the support of Generalized Space-Frequency Block Coding procedure;
At 1704, obtaining measurements or reports of the link's performance degradation, e.g., the SNR degradation caused by beam squint, S1, and/or the SNR degradation caused by beam misalignments, S2;
At 1706 obtaining beam-related scheduling information, e.g., about the beams serving other users or the available transmit power;
At 1708, selecting a function from the codebook of available Transform Spreading functions based a relationship between S1 and T1; for example, if S1>T1, then, at 1710, then selecting a function from a codebook of Transform Spreading functions and proceeding to 1712, otherwise proceeding directly to 1712;
At 1712, if S2>T2 and a diversity beam is permitted, then at 1714 selecting the HN beamwidth and the orientation of a diversity beam and a permission from the scheduler to use the diversity beam and proceeding to 1716, otherwise proceeding directly to 1716; and
At 1716, generating GSFBC-encoded symbols over the configured beams and also sending GSFBC-related control signaling information over one or both of the configured beams or over another one or more beams, and then returning to 1704.
wherein the codebook of Transform Spreading functions may be configured by higher layers, e.g., via RRC configuration information, MAC CE commands, or pre-defined by the implementation.
wherein the thresholds T1 and T2 may be configured by higher-layer messages, e.g., RRC configuration information, MAC CE commands, or pre-defined by the implementation.
wherein the capabilities information may include, e.g., a subset of supported Transform Spreading functions within the codebook, and/or any other restrictions for the transform functions in the codebook, as reported by the second WTRU via a higher-layer message during initial connection establishment.
wherein the link's performance degradation may include, e.g., an SNR degradation caused by beam squint, SNR degradation caused by beam misalignments, CSI measurements, rms error magnitude of CSI measurements, performance statistics, modulation and coding scheme, or user velocity, among others.
wherein the SNR degradation caused by beam squint may be measured by the first WTRU or set of first WTRUs as the difference between the SNR at the farthest and the nearest subcarriers with respect to the DC subcarrier, averaged over a pre-defined number of time slots, TTIs, or radio frames.
wherein the SNR degradation caused by beam misalignments may be measured by the first WTRU or set of first WTRUs as a reduction in the modulation and coding scheme required to maintain a given detection performance in response to the ACK/NACK indications sent by the second WTRU, averaged over a pre-defined number of time slots, TTIs, or radio frames.
wherein the SNR degradation caused by beam misalignments may be measured by the second WTRU as a reduction in the modulation and coding scheme required to maintain a given detection performance according to the measured block-error rate, averaged over a pre-defined number of time slots, TTIs, or radio frames.
wherein the number of time slots, TTIs, or radio frames for averaging of the SNR degradation caused by beam squint or beam misalignments may be configured by higher layers via, e.g., RRC configuration information or DCI control information.
wherein the link's performance degradation may be measured by the second WTRU and reported to the first WTRU or set of first WTRUs via, e.g., a shared control or data channel or a MAC CE command.
wherein the report containing the link's performance degradation caused by beam squint and/or beam misalignments may contain a request to trigger GSFBC encoding of the beams comprising Transform Spreading and/or a diversity beam.
wherein the report containing the link's performance degradation caused by beam squint and/or beam misalignments may be sent by the second WTRU in a periodic, semi-persistent, aperiodic, on-demand, or event-triggered fashion, according to a configuration information received from higher layers, e.g., via RRC signaling or DCI control information.
wherein the function from the codebook of available Transform Spreading functions may be selected by the first WTRU or set of first WTRUs depending on, e.g., the SNR degradation caused by beam squint, S1, the effectiveness in spreading the symbols, the complexity, and/or the capabilities information sent by the second WTRU.
wherein the orientation of the diversity beam may be the same as the main beam if there is no line-of-sight blockage between the first WTRU, or set of first WTRUs, and the second WTRU.
wherein the orientation of the diversity beam may be different than the main beam if there is line-of-sight blockage between the first WTRU, or set of first WTRUs, and the second WTRU, or if the movement of the second WTRU is such that the selected diversity beam maximizes the likelihood of detection.
wherein the H/V beam width of the diversity beam may be increased with respect to the main beam if significant beam misalignment is detected in the H/V direction, or in both.
wherein the H/V beam width of the diversity beam may be increased by exciting a lower number of antennas along the corresponding direction compared to the antennas involved in the transmission of the main beam.
wherein permission to use the diversity beam may be given by the scheduler depending on, e.g., channel conditions, interference with other beams, number of available beams, complexity of the precoding operation, and/or overall power consumption, among others.
wherein GSFBC-encoded symbols may comprise a Transform Spreading step on the main beam, a Transform Spreading step on a diversity beam, or both, depending on, e.g., capabilities information, measurements of SNR degradation, beam-related scheduling information, and/or service needs.
wherein the GSFBC-related control signaling information may contain an indication of GSFBC encoding, and/or an index to the applied Transform Spreading function in the codebook.
wherein the GSFBC-related control signaling information may be sent to the second WTRU by means of a higher-layer RRC configuration information, a DCI control indication, or a MAC CE command.
wherein the first WTRU isa base station equipment and the second WTRU is a user equipment in the downlink of a wireless communication system.
wherein the set of first WTRUs are multiple transmit-receive points in the downlink of a multi-TRP wireless communication system.
wherein the first WTRU and the second WTRU are user equipment in the side link of a wireless communication system.
wherein the first WTRU is a user equipment and the second WTRU is a base station equipment in the uplink of a wireless communication system.

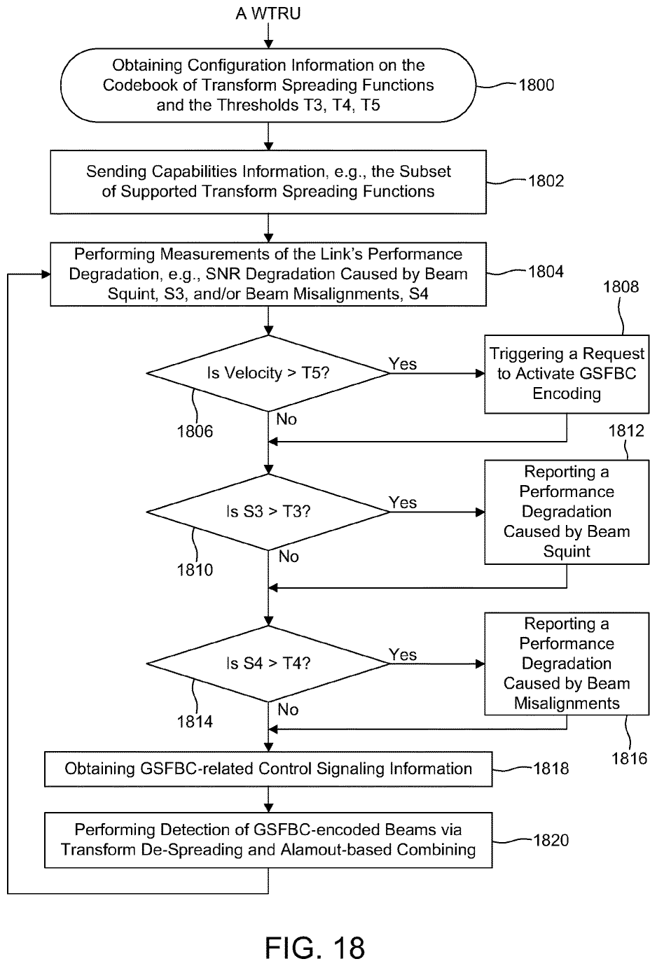

FIG. 18 is a flow diagram of a method related to the reception of GSFBC-encoded signals, according to an embodiment.

Referring to FIG. 18, a first WTRU is receiving wireless signals from a second WTRU or set of second WTRUs, the method characterized by the first WTRU:
At 1800, obtaining configuration information on the codebook of Transform Spreading functions and thresholds T3, T4, T5;
At 1802, sending capabilities information containing, e.g., the subset of supported Transform Spreading functions or any constraints related to the support of Generalized Space-Frequency Block Coding procedure;
At 1804, performing measurements of the link's performance degradation, e.g., the SNR degradation caused by beam squint, S3, and/or the SNR degradation caused by beam misalignments, S4;
At 1806, if the user's velocity >T5, then, at 1808, triggering a request to activate GSFBC encoding and proceeding to 1810; otherwise, proceeding directly to 1810;
At 1810, if S3>T3, then, at 1812, reporting a link's performance degradation caused by beam squint and proceeding to 1814; otherwise, proceeding directly to 1814;
At 1814, if S4>T4, then, at 1816, reporting a link's performance degradation caused by beam misalignments and proceeding to 1818; otherwise, proceeding directly to 1818
At 1818, obtaining GSFBC-related control signaling information and proceeding to 1820; and
At 1820, performing detection of GSFBC-encoded beams by performing Transform de-Spreading and Alamouti-based combining of the symbols in the main and/or diversity beams and returning to 1804.
wherein the codebook of Transform Spreading functions may be configured by higher layers, e.g., via RRC configuration information, DCI information, MAC CE commands, or pre-defined by the implementation.
wherein the thresholds T3, T4 and T5 may be configured by higher-layer messages, e.g., RRC configuration information, DCI information, MAC CE commands, or pre-defined by the implementation.
wherein the capabilities information may contain, e.g., a subset of supported Transform Spreading functions within the codebook, and/or any other restrictions for the transform functions in the codebook, as reported to the second WTRU or set of second WTRUs via a higher-layer message during initial connection establishment.
wherein the link's performance degradation may comprise, e.g., an SNR degradation caused by beam squint, SNR degradation caused by beam misalignments, CSI measurements, rms error magnitude of CSI measurements, performance statistics, modulation and coding scheme, or user velocity, among others.
wherein the SNR degradation caused by beam squint may be measured by the first WTRU as the difference between the SNR at the farthest and the nearest subcarriers with respect to the DC subcarrier, averaged over a pre-defined number of time slots, TTIs, or radio frames.
wherein the SNR degradation caused by beam misalignments may be measured by the first WTRU as a reduction in the modulation and coding scheme required to maintain a given detection performance according to the measured block error rate, averaged over a pre-defined number of time slots, TTIs, or radio frames.
wherein the number of slots, TTIs, or radio frames for averaging of the SNR degradation caused by beam squint or beam misalignments may be configured by higher layers via, e.g., RRC configuration information.
wherein the report containing the link's performance degradation caused by beam squint and/or beam misalignments may be sent by the first WTRU via, e.g., a shared control or data channel, or a MAC CE command.
wherein the report containing the link's performance degradation caused by beam squint and/or beam misalignments may be sent by the first WTRU in a periodic, semi-persistent, aperiodic, on-demand, or event-triggered fashion, according to a configuration information received from higher layers, e.g., via RRC signaling.
wherein the GSFBC-related control signaling information may comprise the selected function in the codebook of Transform Spreading functions.
wherein the GSFBC-related control signaling information may be obtained by the first WTRU via an RRC configuration message, a DCI control indication, or a MAC CE command.
wherein the GSFBC-related control signaling information may be obtained by the first WTRU via blind decoding.
wherein the Transform de-Spreading operation may comprise the inverse of the transform selected by the transmitter among the codebook of Transform Spreading functions.
wherein the first WTRU is a user equipment and the second WTRU is a base station equipment in the downlink of a wireless communication system.
wherein the set of second WTRUs are multiple transmit-receive points in the downlink of a multi-TRP wireless communication system.
wherein the first WTRU and the second WTRU are user equipment in the side link of a wireless communication system.
wherein the first WTRU isa base station equipment and the second WTRU is a user equipment in the uplink of a wireless communication system.

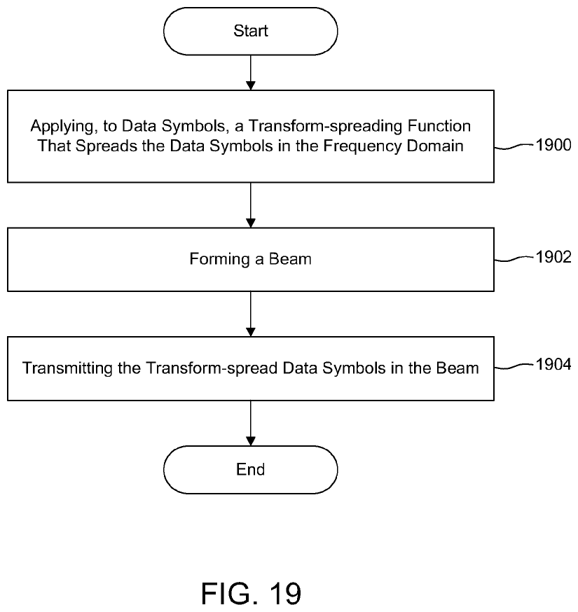

FIG. 19 is a flow diagram of a method for transmitting transform-spread data symbols in a beam according to an embodiment.

Referring to FIG. 19, at 1900, a WTRU applies, to data symbols, a transform-spreading function that spreads the data symbols in the frequency domain. Examples of transform-spreading functions are disclosed elsewhere herein.

At 1902, the WTRU forms a transmit beam. Examples of transmit-beam forming are disclosed elsewhere herein.

At 1904, the WTRU transmits the transform-spread data symbols in (“on” or “over” are other suitable terms) the transmit beam.

Still referring to FIG. 19, although a WTRU is described as transmitting data symbols in a single transmit beam, it is contemplated that the WTRU may form multiple transmit beams and transmit data symbols in multiple transmit beams. For example, the WTRU may form a main transmit beam and a diversity transmit beam and transmit data symbols on both beams. Furthermore, the data symbols transmitted in one beam may be complex conjugates (e.g., with or without sign reversals), of the data symbols in the other beam. Moreover, the beams may have different parameters, e.g., different directions, different half-power beam widths in the azimuth and/or elevation dimensions, different frequencies/wavelengths, different phases, different amplitudes, different powers, and/or may carry data symbols on different subcarriers. In addition, the WTRU may adjust the transform-spreading function and/or one or more of the beams in response to feedback from a receiver of the beams.

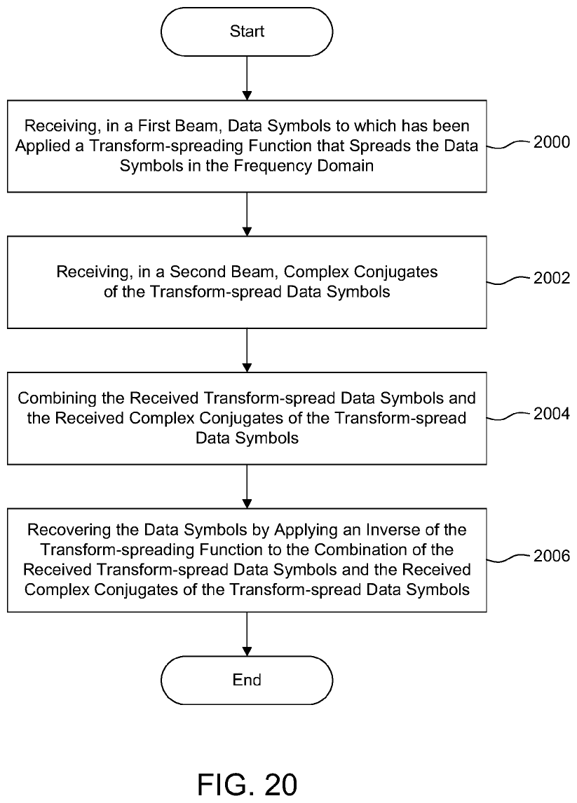

FIG. 20 is a flow diagram of a method for receiving data symbols in multiple beams according to an embodiment.

Referring to FIG. 20, at 2000, a WTRU receives, in a first beam such as a main receive beam, data symbols to which has been applied a transform-spreading function that spreads the data symbols in the frequency domain. Examples of transform-spreading functions are disclosed elsewhere herein.

At 2002, the WTRU receives, in a second beam such as a diversity receive beam, complex conjugates (with or without sign reversal) of the data symbols to which has been applied the transform-spreading function that spreads the complex conjugates in the frequency domain. Examples of a diversity beam are disclosed elsewhere herein.

At 2004, the WTRU combines the received transform-spread data symbols and the received complex conjugates of the transform-spread data symbols. Examples of combining transform-spread data symbols and complex conjugates of the transform-spread data symbols are disclosed elsewhere herein.

At 2006, the WTRU recovers the data symbols by applying an inverse of the transform-spreading function to the combination of the transform-spread data symbols received in the first beam and the complex conjugates received in the second beam.

Still referring to FIG. 20, although a WTRU is described as receiving data symbols and complex conjugates of the data symbols in multiple beams, it is contemplated that the WTRU may receive other combinations of data symbols in multiple beams. For example, the WTRU may receive, in one beam, data symbols that modulate a first set of subcarriers, and may receive, in another beam, data symbols that modulate a second set of subcarriers, where the second set of subcarriers is different from the first set of subcarriers (although there may be some overlap between the first and second sets of subcarriers). Furthermore, the beams may have different parameters, e.g., different directions, different half-power beam widths in the azimuth and/or elevation dimensions, different frequencies/wavelengths, different phases, different amplitudes, different powers, and/or may carry data symbols on different subcarriers. In addition, the WTRU may provide, to a transmitter of the beams, feedback that allows the transmitter to adjust the transform-spreading function and/or one or more parameters of the beams.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-68. (canceled)

69. A method implementable by a wireless transmit/receive unit (WTRU), the method comprising:
applying, to data symbols, a transform-spreading function that spreads the data symbols in a frequency domain to balance an effective channel response of the data symbols;
generating complex conjugates of the transform-spread data symbols;
transmitting the transform-spread data symbols in a first beam; and
transmitting the transform-spread complex conjugates in a second beam.

70. The method of claim 69, wherein the first beam is a main beam, and the second beam is a diversity beam, and wherein the second beam has one or more different characteristics than the main beam in beam direction, beamwidth in a horizontal (H) plane or beamwidth in a vertical (V) plane.

71. The method of claim 69, wherein transmitting the transform-spread data symbols in the first beam includes transmitting the transform-spread data symbols over a first channel having a first channel response, and wherein transmitting the transform-spread complex conjugates in the second beam includes transmitting the complex conjugates of the transform-spread data symbols over a second channel having a second channel response.

72. The method of claim 69, further comprising Alamouti coding of the transform-spread data symbols and the complex conjugates of the transform-spread data symbols.

73. The method of claim 69, further comprising:
transmitting, in the first beam or the second beam, control symbols that are not transform spread.

74. The method of claim 69, wherein transmitting the transform-spread data symbols in the first beam includes modulating subcarriers of the first beam with the transform-spread data symbols, and wherein transmitting the complex conjugates of the transform-spread data symbols in the second beam includes modulating subcarriers of the second beam with the complex conjugates of the transform-spread data symbols.

75. The method of claim 69, further comprising:
receiving a request to improve beam resilience in response to a triggering event.

76. The method of claim 75, wherein the triggering event includes a velocity of a receiving WTRU equaling or exceeding a velocity threshold, performance degradation caused by beam squint equaling or exceeding a beam-squint performance threshold, and/or performance degradation caused by beam misalignment equaling or exceeding a misalignment performance threshold.

77. The method of claim 69, further comprising:
adjusting the transform-spreading function in response to a receiver of the transform-spread data symbols in the first beam and/or the complex conjugates of the transform-spread data symbols in the second beam.

78. The method of claim 69, further comprising:
adjusting the first beam and/or the second beam in response to a receiver of the transform-spread data symbols in the first beam and the complex conjugates of the transform-spread data symbols in the second beam.

79. A wireless transmit/receive unit (WTRU) configured to:
apply, to data symbols, a transform-spreading function that spreads the data symbols in a frequency domain to balance an effective channel response of the data symbols;
generate complex conjugates of the transform-spread data symbols;
transmit the transform-spread data symbols in a first beam; and
transmit the transform-spread complex conjugates in a second beam.

80. The WTRU of claim 79, wherein the first beam is a main beam and the second beam is a diversity beam and wherein the second beam has one or more different characteristics than the main beam in beam direction, beamwidth in a horizontal (H) plane or beamwidth in a vertical (V) plane.

81. The WTRU of claim 79, further configured to:
transmit the transform-spread data symbols in the first beam by transmitting the transform-spread data symbols over a first channel having a first channel response; and
transmit the transform-spread complex conjugates in the second beam by transmitting the complex conjugates of the transform-spread data symbols over a second channel having a second channel response.

82. The WTRU of claim 79, further configured to:
Alamouti code the transform-spread data symbols and the complex conjugates of the transform-spread data symbols.

83. The WTRU of claim 79, further configured to transmit, in the first beam or the second beam, control symbols that are not transform spread.

84. The WTRU of claim 79, further configured to transmit the transform-spread data symbols in the first beam by modulating subcarriers of the first beam with the transform-spread data symbols and to transmit the complex conjugates of the transform-spread data symbols in the second beam by modulating subcarriers of the second beam with the complex conjugates of the transform-spread data symbols.

85. The WTRU of claim 79, further configured to receive a request to improve beam resilience in response to a triggering event.

86. The WTRU of claim 85, wherein the triggering event includes a velocity of a receiving WTRU equaling or exceeding a velocity threshold, performance degradation caused by beam squint equaling or exceeding a beam-squint performance threshold, and/or performance degradation caused by beam misalignment equaling or exceeding a misalignment performance threshold.

87. The WTRU of claim 79, further configured to adjust the transform-spreading function in response to a receiver of the transform-spread data symbols in the first beam.

88. The WTRU of claim 79, further configured to adjust the first beam in response to a receiver of the transform-spread data symbols in the first beam.
